(19) United States
(12) Patent Application Publication
(10) Pub. No.: US 2026/0278165 A1
(43) Pub. Date: Sep. 17, 2026

(54) DEPLOYING AUTONOMOUS SOFTWARE AGENTS AND RETRIEVING SECRETS AS PART OF EXECUTING A SOFTWARE TASK

(71) Applicant: COGNITION AI, INC., San Francisco, CA (US)

(72) Inventors: Tony Jiang, Sunnyvale, CA (US); Scott Wu, Atherton, CA (US); Steven Hao, Atherton, CA (US); Sampriti Panda, Menlo Park, CA (US); Walden Yan, Atherton, CA (US); Adhyyan Sekhsaria, San Francisco, CA (US); Jeffrey Ling, Redwood City, CA (US)

(21) Appl. No.: 19/561,198

(22) Filed: Mar. 9, 2026

Related U.S. Application Data
(60) Provisional application No. 63/770,816, filed on Mar. 12, 2025.

(51) Int. Cl. G06F 21/62

(52) U.S. Cl. CPC G06F 21/6254

(57) ABSTRACT

The present disclosure relates to systems, methods, and non-transitory computer-readable media that deploys an autonomous software agent and determines an activation trigger that indicates an access credential as part of completing a software task. In particular, the disclosed systems receive a prompt to execute a software task and determine (e.g., via an autonomous software agent) an activation trigger that indicates an access credential is required as part of completing the software task. Moreover, the disclosed systems make a call for a token corresponding to the access credential based on the activation trigger. Furthermore, the disclosed systems receive the token in an independent virtual machine computing environment and use the token to complete the software task.

### CROSS REFERENCE TO RELATED APPLICATIONS

This application claims the benefit of and priority to U.S. Provisional Application No. 63/770,816, filed Mar. 12^{th}, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of computational efficiency, technical accuracy, operational flexibility, and security.

### SUMMARY

One or more embodiments described herein provide benefits and/or solve one or more problems in the art with systems, methods, and non-transitory computer-readable media that deploy autonomous software agents and determine an activation trigger as part of executing a software task that indicates an access credential. To illustrate, in one or more embodiments, the disclosed systems execute one or more portions of a software task and detect/determine an activation trigger that points to an access credential. Moreover, in one or more embodiments, the disclosed systems make a call for a token corresponding to an access credential based on the activation trigger. Specifically, in response to the call for the token, the disclosed systems receive the token in an independent virtual machine computing environment of the autonomous software agent. Moreover, in some embodiments, the disclosed systems utilize, by the autonomous software agent, the token to complete the software task.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system deploying an autonomous software agent and determining an activation trigger in accordance with one or more implementations;

FIG. 2 illustrates an example diagram of the autonomous software agent system generating a secrets library in accordance with one or more implementations;

FIG. 3 illustrates an example diagram of the autonomous software agent system detecting an activation trigger for an access credential from executing a software task in accordance with one or more implementations;

FIG. 4 illustrates an example diagram of the autonomous software agent system detecting an access credential as a confidential token and injecting the confidential token within environment variables in accordance with one or more implementations;

FIG. 5 illustrates an example diagram of the autonomous software agent system translating access credentials to be valid computer environment variables in accordance with one or more embodiments;

FIG. 6 illustrates an example diagram of the autonomous software agent system deploying an autonomous software agent with access to a plurality of software composition tools in accordance with one or more embodiments;

FIGS. 7A-7B illustrate example graphical user interfaces of the autonomous software agent system providing a secrets interface to create an access credential (secret) in accordance with one or more implementations;

FIGS. 8A-8B illustrate example graphical user interfaces of the autonomous software agent system prompting a user computing device to provide an access credential in accordance with one or more implementations;

FIG. 9 illustrates an example graphical user interface of the autonomous software agent system receiving an access credential scoped to a specific code repository in accordance with one or more embodiments;

FIG. 10 illustrates an example diagram of an architectural layer design of the autonomous software agent system which accesses various artificial intelligence models to enable an independent virtual machine computing environment of an autonomous software agent in accordance with one or more implementations;

FIG. 11 illustrates an example diagram of a virtual private cloud housing an independent virtual machine computing environment that is in communication with an autonomous agent model backend in accordance with one or more implementations;

FIG. 12 illustrates an example diagram of a frontend layer interacting with an autonomous software agent system ingestion layer and a virtual private cloud in accordance with one or more implementations;

FIG. 13 illustrates an example environment of the autonomous software agent system in accordance with one or more implementations;

FIG. 14 illustrates an example series of acts for receiving a token in an independent virtual machine computing environment of an autonomous software agent in accordance with one or more implementations; and

FIG. 15 illustrates a block diagram of an exemplary computing device in accordance with one or more implementations.

### DETAILED DESCRIPTION

One or more embodiments described herein includes an autonomous software agent system that securely shares credentials with an autonomous software agent to access a variety of different software composition tools. To illustrate, in one or more embodiments, an autonomous software agent system 100 deploys an autonomous software agent to independently complete software development tasks such as writing computer code tests, adding features to an existing code repository, adding functionality to an existing codebase, developing prototypes, and building integrations between software applications. In one or more embodiments, a task/sub-task of a software task indicates an access credential, and the autonomous software agent system 100 detects an activation trigger from an autonomous software agent executing the software task. In particular, the autonomous software agent system 100 determines an activation trigger and makes a call for a relevant token corresponding to the access credential based on the activation trigger. In some embodiments, the autonomous software agent system 100 receives the token in an independent virtual machine computing environment of the autonomous software agent and utilizes the token to complete (a task/sub-task) the software task.

In one or more embodiments, the autonomous software agent system 100 generates a large language model relevance prompt to determine (e.g., via a large language model) that a task/sub-task indicates an activation trigger. In other words, the autonomous software agent system 100 utilizes retrieval augmented generation (RAG) to detect the context of a task/sub-task. Furthermore, in some embodiments, the autonomous software agent system 100 utilizes RAG to determine an activation trigger for the task/sub-task and identifies a corresponding access credential (e.g., within a secrets library).

In some embodiments, the autonomous software agent system 100 detects that a token corresponding to an access credential is a confidential token. In such cases, the autonomous software agent system 100 can scrub the token from being viewed by a large language model component of the autonomous software agent. In particular, the autonomous software agent system 100 can inject the confidential token into computer environment variables of an independent virtual machine computing environment of the autonomous software agent, such that the confidential token is not visible/accessible to the large language model component of the autonomous software agent.

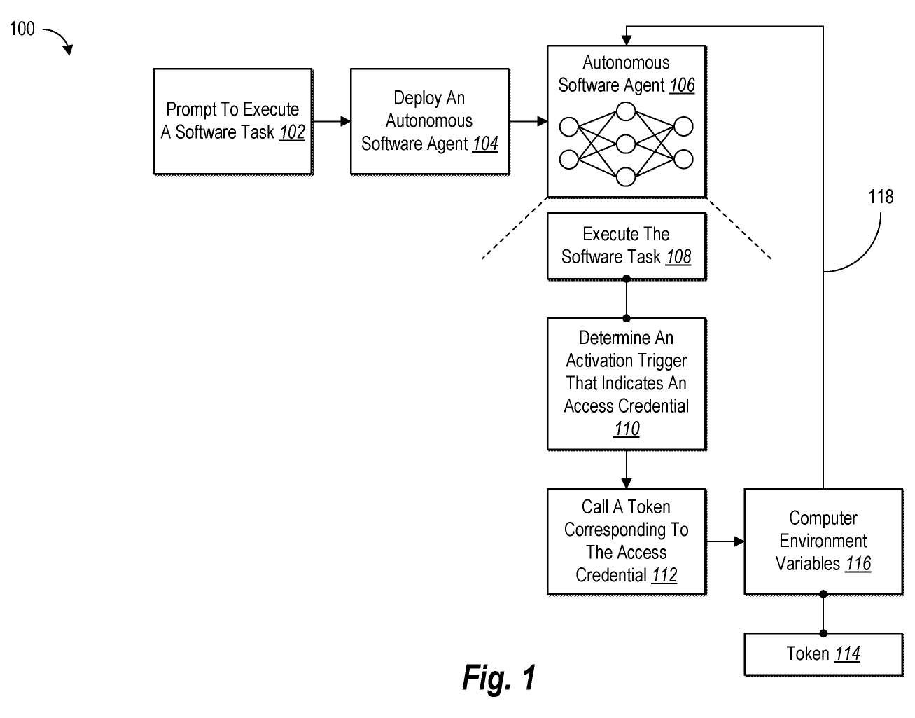

FIG. 1 illustrates an overview diagram of the autonomous software agent system 100 calling a token to provide to an autonomous software agent in accordance with one or more embodiments. For example, FIG. 1 shows the autonomous software agent system 100 receiving a prompt 102 to deploy an autonomous software agent. In some embodiments, the autonomous software agent system 100 receives the prompt 102 (e.g., via a chat interface between a user and the autonomous software agent system 100). In particular, the autonomous software agent system 100 provides a chat interface via a web browser, or a web application.

In one or more embodiments, the autonomous software agent system 100 further performs an act 104 of deploying an autonomous software agent (e.g., a cloned virtual machine that is isolated and can perform tasks siloed from other virtual machine computing devices). In particular, the autonomous software agent system 100 performs the act 104 of deploying an autonomous software agent 106 within an independent virtual machine computing environment and the autonomous software agent 106 generates and runs code in its own isolated environment.

In one or more embodiments, the independent virtual machine computing environment refers to a software-based simulation that independently runs its own operating system and applications as a standalone machine. For example, a virtual machine computing environment 204 refers to a software-implemented computational environment that emulates a physical computing system and provides an isolated, executable runtime environment for code generation, execution, testing, modification, or orchestration by the autonomous software agent system 100. In one or more embodiments, the virtual machine computing environment 204 may operate as a system-level virtualization layer (e.g., hypervisor-based virtual machine), an operating system–level container, a language runtime virtual machine, or a custom execution sandbox, and may be dynamically provisioned, configured, and decommissioned under control of the virtual machine computing environment 204. Thus, a deployed autonomous software agent independently leverages its own independent computing environment.

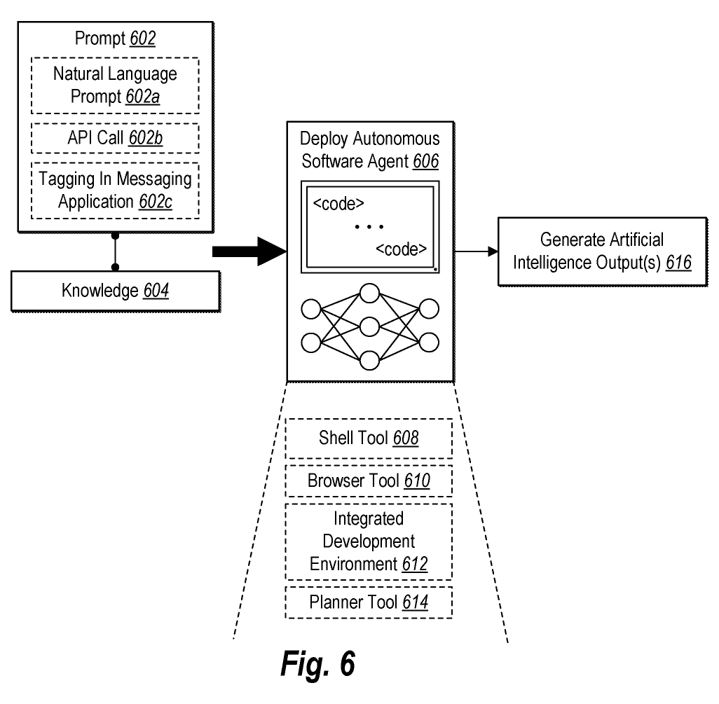

In other words, the autonomous software agent exists independently of a computing device of a user who submitted a prompt to deploy the autonomous software agent and performs tasks based on knowledge that is provided to it. Moreover, the autonomous software agent system 100 further provides to the autonomous software agent computer software composition tools. Details pertaining to the computer software composition tools are given in more detail below in the description of FIG. 6.

In one or more embodiments, the autonomous software agent system 100 provides the autonomous software agent 106 with its own software development environment (e.g., the independent virtual machine computing environment with access to the computer software composition tools) to perform individualized tasks and not merely supplementary tasks (e.g., the autonomous software agent 106 can deploy its own codebase by replicating an existing codebase, make changes to an existing codebase, implement changes to a codebase, and run tests for computer code generated by an autonomous software agent).

In some embodiments, the autonomous software agent 106 includes a set of artificial intelligence models. In particular, the autonomous software agent 106 includes one or more machine learning models, neural networks, large language models, chain-of-thought reasoning models, and/or vision-language models. Thus, the autonomous software agent system 100 deploys an autonomous software agent that operates within an independent virtual machine computing device with various machine learning components used to analyze, process, and generate information.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a language model includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence. Simply put, the autonomous software agent system 100 uses a model that is trained to predict the next word in a sentence.

A language model is called a large language model (LLM) when it is trained on an enormous amount of data (e.g., a threshold amount of data) and/or has a large number of parameters. These models have capabilities ranging from writing a simple essay to generating complex computer codes – all with limited to no supervision. Accordingly, an LLM can comprise a deep neural network that is very large (billions to hundreds of billions of parameters) and understands, processes, and produces human natural language by being trained on massive amounts of text.

These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include an LLM trained using reinforcement learning techniques that enable the LLM to refine its reasoning skills through iterative feedback.

Additionally, FIG. 1 shows the autonomous software agent system 100 executing a software task 108. In one or more embodiments, the software task 108 refers to a defined unit of work in a software project to be planned, assigned, executed and/or completed. For example, the software task 108 refers to a specific software component for the autonomous software agent system 100 to build, change, fix, and/or maintain based on requirements of the prompt 102. In other words, the software task 108 refers to a discrete, actionable piece of work that contributes to the development, maintenance, or improvement of a software system.

More specifically, a software task refers to a defined computational objective, instruction set, or problem specification that can be satisfied through the generation, modification, execution, analysis, or orchestration of computer-executable code by an artificial intelligence (AI) code-writing agent.

A software task may be expressed in natural language, structured prompts, formal specifications, source code fragments, test cases, API definitions, configuration files, user stories, or any combination thereof. In one or more embodiments, a software task defines one or more functional, logical, structural, or performance requirements that constrain or guide code generation or transformation. For example, a software task may include, without limitation: generating source code implementing specified functionality; translating code between programming languages or frameworks; completing partial code segments; refactoring, optimizing, or modifying existing code; debugging code based on error messages, stack traces, or failing tests; generating unit tests, integration tests, or documentation; constructing data pipelines, scripts, or infrastructure definitions; performing static or dynamic analysis and producing corrective modifications; or orchestrating multi-step development workflows involving code synthesis and validation.

In one or more embodiments, a software task may further include associated constraints such as target programming language, runtime environment, library dependencies, security policies, performance thresholds, coding standards, or interface requirements. In some embodiments, a software task may be decomposed into subtasks, iteratively refined, validated against automated test harnesses, or dynamically modified based on intermediate execution results. The autonomous software agent system 100 may autonomously interpret, prioritize, sequence, and execute one or more software tasks within a broader development objective. Unless expressly limited, a software task encompasses any machine-interpretable or human-specified objective that can be fulfilled, in whole or in part, through automated code generation or code manipulation.

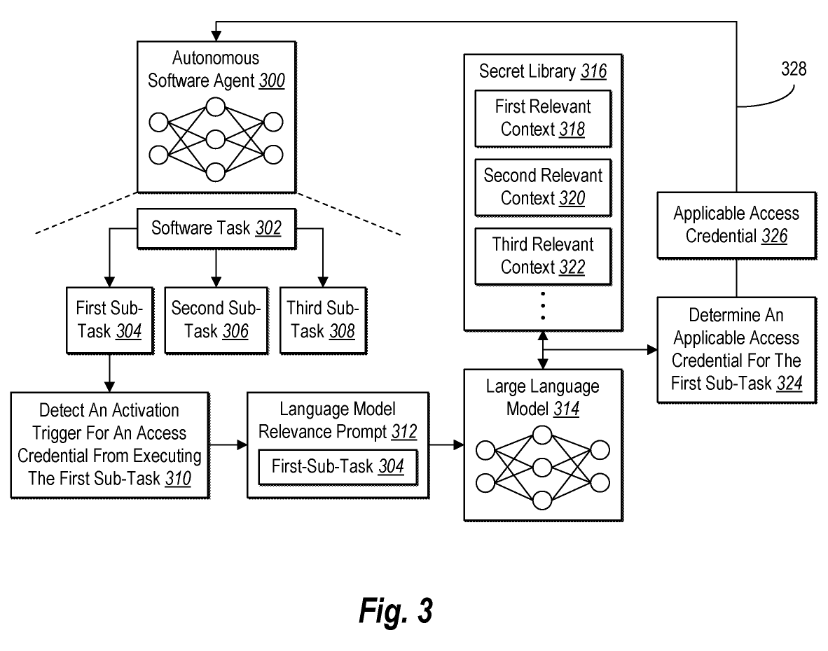

As shown in FIG. 1, as the autonomous software agent system 100 executes the software task 108 utilizing the autonomous software agent 106, the autonomous software agent system 100 performs an act 110 of determining an activation trigger that indicates an access credential. Specific details regarding determining an activation trigger are given below in the description of FIG. 3.

Furthermore, FIG. 1 shows the autonomous software agent system 100 performing an act 112 of calling a token corresponding to an access credential. For instance, the autonomous software agent system 100 determines an activation trigger as part of executing the software task 108 and further identifies a relevant token corresponding to an access credential (e.g., from a library of secrets).

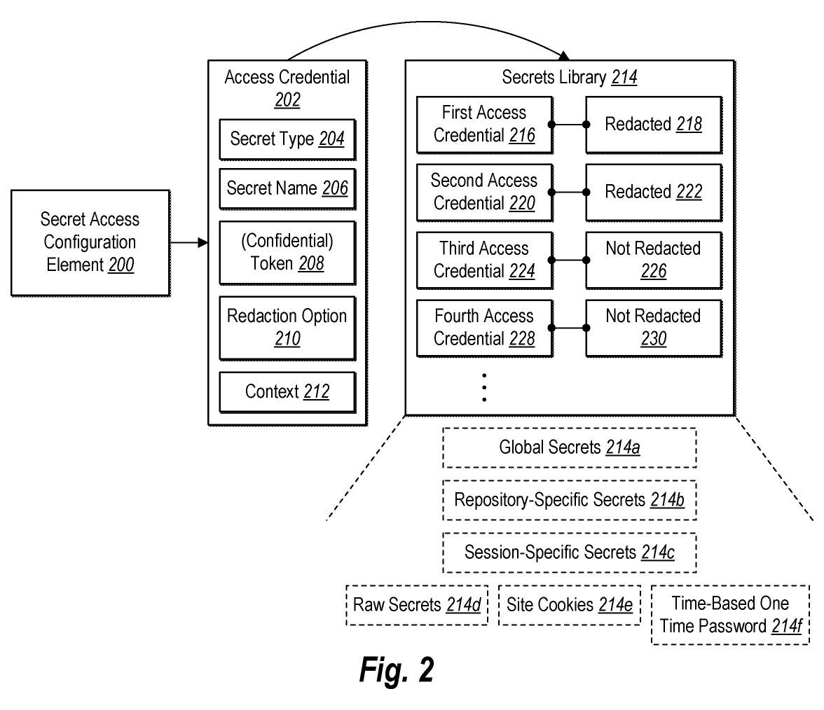

Additionally, FIG. 1 shows the autonomous software agent system 100 providing a token 114 within computer environment variables 116. In particular, FIG. 1 shows the autonomous software agent system 100 performing an act 118 of providing the token 114 within the computer environment variables 116 to be accessible by the autonomous software agent 106. Additional details relating to tokens and types of tokens are given below in the description of FIG. 2.

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer’s device in order to supplement developer work. In other words, existing systems merely act as a co-pilot to a developer. Accordingly, existing systems suffer from computational inefficiencies of attempting to integrate a code development assistant into a developer’s workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer’s task, however it is often difficult or impossible to follow/understand the thought process of existing code generation systems when writing computer code. Often, existing code generation systems are a black box that receive instructions and output computer code (e.g., which results in difficulties in understanding how the existing code generation system arrived at its answer). As such, modifying intermediate steps of a (supplementary) software coding task performed by existing code generation systems is often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck operating as a co-pilot developer to merely supplement a software developer’s workflow.

Moreover, some existing systems are insecure. While certain existing systems can assist developers in supplementing computer code, these systems generally require developers to provide sensitive information. By providing sensitive information to these existing systems, developers unwillingly expose their software applications to malicious attacks or risk leaking the information to unwanted third-party applications.

In one or more embodiments, the autonomous software agent system 100 provides several improvements over conventional systems in relation to technical accuracy, computational efficiency, operational flexibility, and computational security. In contrast to existing systems, which require heavily involved guidance, prompting, monitoring, and the use of a developer’s device (in order to supplement developer work), the autonomous software agent system 100 deploys an autonomous software agent that operates as an independent virtual machine computing device.

In doing so, the autonomous software agent system 100 allows for an autonomous software agent to operate independently to solve non-trivial tasks, and it does not conflate or confuse the context of other ongoing tasks. Specifically, the autonomous software agent system 100 silos/isolates autonomous software agents (e.g., to operate independently with fully featured computer software composition tools discussed in more detail in FIG. 6) such that the autonomous software agents can accurately perform their assigned software tasks without being bogged down by additional information.

In one or more embodiments, the autonomous software agent system 100 further improves upon technical inaccuracies by analyzing contextual windows of a plurality of sub-tasks while executing a software task. In some embodiments, the autonomous software agent system 100 determines a contextual window (e.g., a cue) of a sub-task that points to an activation trigger (e.g., a sub-task requires an access credential). In detecting a specific activation trigger for a specific sub-task, the autonomous software agent system 100 further identifies a corresponding access credential to the activation trigger and provides a token to an autonomous software agent.

In doing so, the autonomous software agent system 100 improves the technical accuracy of the autonomous software agent executing a software task as the autonomous software agent can receive a token in an independent virtual machine computing environment as it executes a software task. In other words, the autonomous software agent system 100 improves the success rate of executing the software task by injecting relevant secrets (e.g., tokens) into a computing environment of an autonomous software agent.

In one or more embodiments, the autonomous software agent system 100 further improves upon technical inaccuracies. In contrast to existing systems, which are often incomplete or inadequate in generating complex and extensive computer code, the autonomous software agent system 100 deploys an autonomous software agent that uses an intelligent orchestration process to determine how to understand a relevant code repository/environment, how to generate artificial intelligence outputs (e.g., computer code) that match a determined context, and how to choose between various artificial intelligence models to accomplish various software tasks. In some embodiments, the autonomous software agent system 100 allows a user of a computing device to configure an autonomous software agent environment and then deploys the autonomous software agent to complete a software task, thus improving the technical accuracy of artificial intelligence agents performing software tasks (e.g., relative to existing systems).

In one or more embodiments, the autonomous software agent system 100 enables a user computing device to follow the work of an autonomous software agent as it performs a software coding task. For example, the autonomous software agent system 100 displays commands submitted by the autonomous software agent via a terminal, computer code being written by the autonomous software agent via an editor, and computer code being debugged by the autonomous software agent. As such, the autonomous software agent system 100 enables a user of a computing device to more accurately understand the manner in which an autonomous software agent arrived at a final result (e.g., the user computing device can follow the autonomous software agent in real-time).

Moreover, in some embodiments, the autonomous software agent system 100 prompts (e.g., via a chat interface) a user computing device to save an access credential in a secrets library. In particular, when executing a software task, the autonomous software agent system 100 can identify certain inputs and suggest to a user computing device to store the inputs as secrets for future development sessions. In doing so, the autonomous software agent system 100 improves the technical accuracy of future development sessions by potentially drawing from inputs that were helpful in successfully accomplishing a previous software task.

Relatedly, the autonomous software agent system 100 also improves computational efficiency of software tasks by enabling options for a user computing device to follow an autonomous software agent executing a software task. In particular, as mentioned, the autonomous software agent can operate independently, and in some instances, a user can intervene or understand the steps/thought processes of an autonomous software agent by following the autonomous software agent as it switches between using different computer software composition tools.

In particular, a user computing device can follow an autonomous software agent as it switches between different computer software composition tools to execute a software task. In doing so, the autonomous software agent system 100 saves computational resources and time as a user can more efficiently understand the process of an autonomous software agent (e.g., as it performs a task or after it performs a task) and the user can intervene at one or more points in the development session to aid/assist an autonomous software agent.

Moreover, as mentioned above, the autonomous software agent system 100 can provide access credentials to an autonomous software agent in response to an activation trigger being detected. In particular, the autonomous software agent system 100 improves computational efficiency by quickly accessing relevant access credentials (e.g., tokens) for executing a sub-task that indicates an access credential trigger.

As also mentioned above, the autonomous software agent system 100 can prompt a user computing device to save certain inputs as secret inputs for future development sessions or for subsequent sub-tasks within the same development session. In doing so, the autonomous software agent system 100 also improves computational efficiency as saved secret inputs (e.g., based on the autonomous software agent system 100 prompting the user computing device) allow the autonomous software agent system 100 to more seamlessly move through software development pipelines when encountering types of software tasks that are similar to previously executed software tasks.

Furthermore, the autonomous software agent system 100 improves computational efficiency by enabling a user computing device to continue to delegate entire non-trivial software coding tasks to the autonomous software agent while the autonomous software agent is already working completely asynchronously. As the autonomous software agent is executing a software coding task, a user can delegate multiple additional autonomous software agents to perform additional software tasks. Thus, the autonomous software agent system 100 enables large-scale parallelization of tasks.

In one or more embodiments, the autonomous software agent system 100 further improves upon operational inflexibilities. In contrast to existing systems, which are rigidly tied to code supplementation, the autonomous software agent system 100 deploys an autonomous software agent that operates within an independent virtual machine computing environment and further allows a user to monitor/modify the progress of the autonomous software agent (if so desired). Moreover, because the autonomous software agent system 100 deploys an autonomous software agent that is provided with various development box tools, the autonomous software agent acts as an advanced reasoning tool to complete non-trivial tasks. Accordingly, the autonomous software agent system 100 enhances the flexibility of operations in performing code generation tasks relative to existing systems.

Additionally, in some embodiments, the autonomous software agent system 100 enhances security relative to existing systems. For example, the autonomous software agent system 100 provides an option to provide a set of access credentials and causes the autonomous software agent to reference the set of access credentials as computer development environment variables. In other words, access credentials are hidden from large language model components (e.g., third-party models) and other artificial intelligence models that an autonomous software agent may employ. In particular, the autonomous software agent system 100 can use an autonomous software agent to invoke a computer development environment variable to utilize an access credential which insulates software applications from malicious attacks and reduces the risk of leaking information to unwanted third-party applications. These and other technical improvements are made more clear in the description of the figures below.

FIG. 2 illustrates the autonomous software agent system 100 generating a secrets library in accordance with one or more embodiments. For example, FIG. 2 shows the autonomous software agent system 100 providing a secret access configuration element 200. In particular, the autonomous software agent system 100 provides the secret access configuration element 200 within a graphical user interface of a user computing device. In response to a selection of the secret access configuration element 200, the autonomous software agent system 100 can receive an access credential from the user computing device.

As shown in FIG. 2, the autonomous software agent system 100 receives a selection of the secret access configuration element 200 and prompts a user computing device for an access credential 202. In particular, the access credential 202 can include a secret type 204, a secret name 206, a token 208 (e.g., a confidential token), a redaction option 210, and context 212.

In one or more embodiments, the access credential 202 refers to a set of information used to authenticate and authorize access to a system, service, resource, or computing environment. For example, the access credential 202 refers to a proof of identity and defines what actions a holder of the access credential 202 is permitted to perform. Furthermore, in some embodiments, the access credential 202 includes the aforementioned secret type, secret name, token, redaction option, and context.

In one or more embodiments, the secret name 206 refers to a human-readable identifier used to reference and manage the access credential 202. In particular, the secret name 206 refers to a label and does not grant access by itself. For instance, the secret name 206 can assist a computer system in auditing, configuring, and troubleshooting problems related to the access credential 202 (e.g., the secret name 206 acts as a reference). In one or more embodiments, the token 208 refers to a secret or cryptographic value that is actually presented to a system to authenticate access. In particular, the token 208 refers to an API key, an OAuth token, and other private keys.

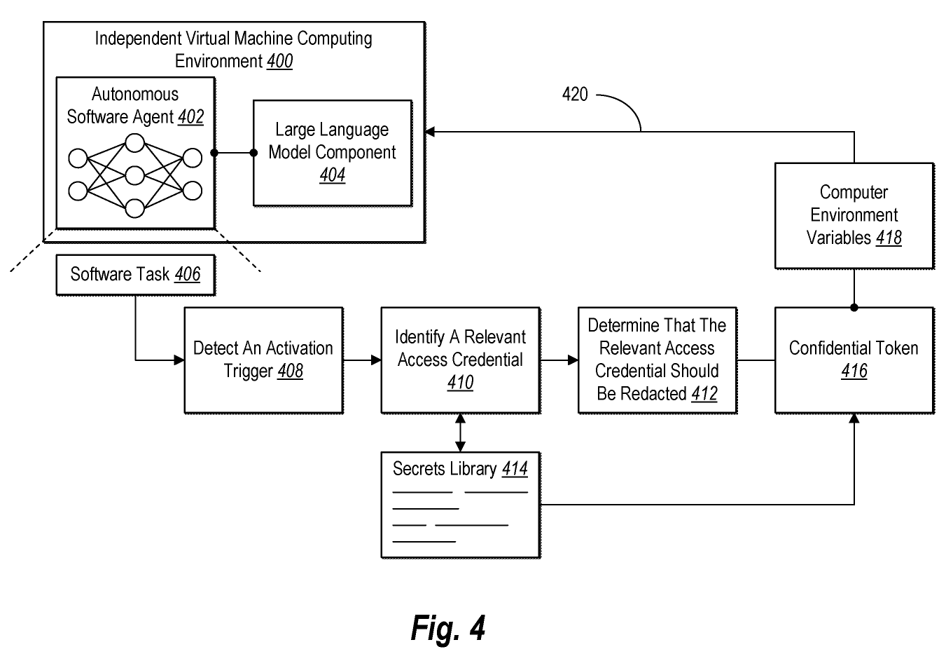

In one or more embodiments, the redaction option 210 refers to an option that defines whether the access credential 202 is masked, hidden, or excluded when displayed, logged, or transmitted. For example, the autonomous software agent system 100 can scrub the token 208 from being viewed/accessed by a large language model component (e.g., a third-party model called by an autonomous software agent) of an autonomous software agent executing a software task. More details regarding this are given below in the description of FIG. 4.

In one or more embodiments, the context 212 of the access credential 202 refers to the scope and conditions under which the access credential 202 is valid and intended to be used. In particular, the context 212 can include the associated system or service for the access credential 202, an environment (e.g., development, staging, or production) for using the access credential 202, permissions or roles for using the access credential 202, expiration or rotation rules for the access credential 202, and usage constraints (e.g., internet protocol range, region restrictions, time restrictions, workload restrictions) of the access credential 202.

In one or more embodiments, the autonomous software agent system 100 enforces a role-based access control (RBAC) policy governing creation, modification, deletion, and injection of access credentials. Each access credential may be associated with an access control list defining permitted roles, including administrator roles, developer roles, and session-scoped roles. Prior to decrypting or injecting a token, the autonomous software agent system 100 verifies that the requesting user account and development session satisfy the applicable RBAC policy.

The autonomous software agent system 100 further generates audit log entries for secret creation, modification, deletion, injection, expiration, and failed access attempts. Audit logs may be stored in a logging system and may include timestamps, user identifiers, session identifiers, and secret identifiers without exposing token values.

In one or more embodiments, the autonomous software agent system 100 enforces expiration and rotation policies by associating each access credential with a time-to-live (TTL) parameter or expiration timestamp. During activation trigger detection or token call operations, the autonomous software agent system 100 validates that the current time is within a valid interval for the access credential. If an access credential is expired, the autonomous software agent system 100 prevents injection and prompts for updated credentials. In some embodiments, the autonomous software agent system 100 utilizes a background secret rotation service that periodically identifies credentials approaching expiration and may notify authorized users, automatically request updated values, or temporarily disable injection eligibility until rotation is completed.

Additionally, FIG. 2 shows the autonomous software agent system 100 receiving the access credential 202 and storing the access credential 202 within a secrets library 214. In particular, FIG. 2 shows that the secrets library 214 includes a first access credential 216 with a selection of a redaction option 218, a second access credential 220 with a selection of a redaction option 222, a third access credential 224 without a selection of a redaction option 226, and a fourth access credential 228 without a selection of a redaction option 230 (e.g., a corresponding token does not have to be redacted).

Additionally, FIG. 2 illustrates different types of secrets (e.g., the secret type 204) saved within the secrets library 214. For example, FIG. 2 shows global secrets 214a, repository-specific secrets 214b, session-specific secrets 214c, raw secrets 214d, site cookies 214e, and time-based one-time password 214f. In one or more embodiments, the global secrets 214a refer to access credentials that are usable by an autonomous software in future development sessions. For example, the global secrets 214a refer to broad or system-wide access across multiple resources, repositories, services, or environments for autonomous software agents executing software tasks. In particular, the autonomous software agent system 100 persists the global secrets 214a to future development sessions and applies to an entire organization account (e.g., any user account within an organization account can access the global secrets 214a after they have been added).

In one or more embodiments, the autonomous software agent system 100 resolves conflicts among secrets sharing identical secret names across different scopes using a defined precedence hierarchy. For example, session-specific secrets 214c may override repository-specific secrets 214b, and repository-specific secrets 214b may override global secrets 214a. In one or more embodiments, during activation trigger resolution, the autonomous software agent system 100 selects the highest-precedence eligible secret whose context matches the current sub-task. This hierarchical resolution mechanism prevents ambiguity and ensures predictable injection behavior.

The global secrets 214a are usable by autonomous software agents in all future development sessions within the entire organization. In one or more embodiments, the autonomous software agent system 100 persists the global secrets 214a to an autonomous software agent for development sessions created after a user computing device added a global secret. In some embodiments, the autonomous software agent system 100 encrypts tokens corresponding to the global secrets 214a. Further, in some embodiments, all user accounts that are part of an organization can utilize the global secrets 214a. Additionally, in some embodiments, the autonomous software agent system 100 grants administrator accounts permissions to view and edit existing global secrets.

In one or more embodiments, the autonomous software agent system 100 encrypts each token corresponding to an access credential using envelope encryption prior to any storage. The autonomous software agent system 100 may generate a data encryption key (DEK) for each access credential and encrypt the DEK using a master key managed by a key management service (KMS) or hardware security module (HSM). The autonomous software agent system 100 stores encrypted token values separately from encrypted key material to prevent unauthorized reconstruction.

Decryption of a token occurs only within a secure execution boundary and only upon verifying secret eligibility, role-based access permissions, and activation trigger validation. In some embodiments, decrypted tokens exist solely in volatile memory and are never written to persistent storage in plaintext form. Key rotation policies may be enforced by periodically regenerating encryption keys and re-encrypting stored secret material.

In one or more embodiments, the autonomous software agent system 100 associates each access credential stored in the secrets library 214 with a creation timestamp and a session eligibility parameter. Upon initializing a development session comprising an independent virtual machine computing environment, the autonomous software agent system 100 determines a session start timestamp and computes a set of eligible secrets by comparing the session start timestamp with the creation timestamps of stored access credentials. In particular, the autonomous software agent system 100 restricts availability of an access credential to development sessions that are instantiated after the access credential is created, thereby preventing retroactive injection of newly created secrets into previously instantiated sessions.

In some embodiments, the autonomous software agent system 100 maintains a session–secret association table that records which access credentials are authorized for injection into a given development session. The association table may be generated at session initialization and may include references to secret identifiers without exposing underlying token values. In certain implementations, secret material is not copied into the independent virtual machine computing environment at session initialization but instead remains encrypted within a secure storage service until an activation trigger occurs. Accordingly, secret eligibility is enforced at both session initialization time and token retrieval time.

In one or more embodiments, the repository-specific secrets 214b refer to access credentials that grant access to an autonomous software agent within a single repository or narrowly defined resources. In particular, the autonomous software agent system 100 scopes secrets to a specific repository. In one or more embodiments, the session-specific secrets 214c refer to temporary credentials issued for the duration of a single authenticated development session. In other words, the session-specific secrets 214c refer to short-lived and automatically expiring access credentials that can be provided to an autonomous software agent. To illustrate, the autonomous software agent system 100 can prompt a user computing device to provide credentials (e.g., API keys, logins, etc.) while executing a software task.

In one or more embodiments, the raw secrets 214d refer to access credentials that are unprocessed, unmasked, and in a usable form. For example, the raw secrets 214d refer to un-encrypted, un-hashed, or un-redacted tokens. In particular, the raw secrets 214d can refer to generic secrets with a single value. For instance, the secret name 206 is associated with a single secret value. To illustrate, examples of the raw secrets 214d include API keys, SSH keys, usernames or passwords, and tokens. In some embodiments, if the autonomous software agent system 100 detects that a single secret requires multiple values, the autonomous software agent system 100 prompts the user computing device to make distinct secrets for each value (e.g., repository_username and repository_password can be stored as two raw secrets).

In one or more embodiments, the site cookies 214e refer to pieces of data stored by a website in a user computing device’s browser to maintain state, identity, or preferences across multiple different requests. For example, the site cookies 214e can refer to session-specific access credentials. In some embodiments, the site cookies 214e can include session identifiers and authentication tokens. In other words, the autonomous software agent system 100 can receive a specific type of state for a website based on the site cookies 214e.

In one or more embodiments, the site cookies 214e hold a user computing device’s authenticated state. In particular, the autonomous software agent system 100 can receive cookies from a user computing device to make sure that an autonomous software agent is automatically logged in for a website. In some embodiments, the autonomous software agent system 100 may require additional username or password secrets in addition to the site cookies 214e.

In some embodiments, the autonomous software agent system 100 stores the site cookies 214e as base 64 encoded strings (e.g., binary-to-text encoding scheme that converts raw binary data into a sequence of printable ASCII characters). In particular, the autonomous software agent system 100 stores the site cookies 214e as delimited JSON arrays in a standard chromium cookie format (e.g., an internal storage mechanism within a SQLlite database). To illustrate, the autonomous software agent system 100 can receive the site cookies 214e by a user computing device logging in to an account and the user computing device further sharing the cookies that are generated from logging in (e.g., via a browser extension that collects generated cookies).

In one or more embodiments, the time-based one-time password 214f refers to short-lived numeric or alphanumeric codes generated from a shared secret and current time. In particular, the time-based one-time password 214f refers to a password valid for only a brief time window. In some embodiments, the time-based one-time password 214f refers to a password used for multi-factor authentication. In some embodiments, the time-based one-time password 214f is generated by authenticator applications or hardware tokens.

To illustrate, the autonomous software agent system 100 can receive information (e.g., from a user computing device) provided at the time of setting up two-factor authentication. In particular, the autonomous software agent system 100 can receive configuration settings to set up an authenticator. For example, the autonomous software agent system 100 can receive a QR code (e.g., from a user computing device) for setting up an authenticator and the autonomous software agent system 100 can store the QR code within a secrets library to be able to validly replicate the time-based one-time password 214f.

FIG. 3 illustrates the autonomous software agent system 100 determining an activation trigger in accordance with one or more embodiments. For example, FIG. 3 shows the autonomous software agent system 100 utilizing an autonomous software agent 300 to execute a software task 302. In particular, FIG. 3 shows the software task 302 as including a first sub-task 304, a second sub-task 306, and a third sub-task 308.

As shown in FIG. 3, in some embodiments, the autonomous software agent system 100 performs an act 310 of detecting an activation trigger for an access credential from executing the first sub-task 304. As further shown, the autonomous software agent system 100 can generate a language model relevance prompt 312 that includes the first sub-task 304. As shown, the autonomous software agent system 100 provides the language model relevance prompt 312 to a large language model 314.

In one or more embodiments, the language model relevance prompt 312 refers to guidance instructions such as the context of the first sub-task 304, a prompt (e.g., submitted by a user computing device), information pertaining to a secrets library 316 (e.g., how to access the activation triggers within the secrets library 316) and information to determine which activation trigger (if any) is applicable to the context of the first sub-task 304. In some embodiments, the autonomous software agent system 100 directly provides metadata/data packets relating to the activation triggers stored within the secrets library 316 to the large language model 314 (e.g., to determine a relevant activation trigger).

As shown in FIG. 3, the autonomous software agent system 100 performs an act of determining a relevant activation trigger. In one or more embodiments, the autonomous software agent system 100 utilizes the large language model 314 that leverages retrieval-augmented generation (RAG) to determine a relevance of a sub-task. In some embodiments, retrieval-augmented generation refers to retrieving relevant information from an external database and/or the secrets library 316 in the context of a prompt (e.g., that indicates the software task 302).

In some embodiments, the autonomous software agent system 100 can utilize RAG (e.g., which includes using the large language model 314) to generate a response (e.g., determining a relevant activation trigger in the secrets library 316) by leveraging both the retrieved information (from an external source such as from an external environment of the sub-task that the autonomous software agent system 100 is executing) and its own internal sources (e.g., the secrets library 316). In particular, the autonomous software agent system 100 leverages RAG, which includes an input query, information retrieval, and response generation to perform a task of determining the relevance of a sub-task with respect to the secrets library 316. In other words, the autonomous software agent system 100 determines if a current sub-task requires a specific access credential within the secrets library 316 based on the context of the current sub-task matching the context of an access credential within the secrets library 316.

In some embodiments, the autonomous software agent system 100 provides a generated large language model relevance prompt and a context of a current sub-task to the large language model 314, and the large language model 314 generates an artificial intelligence output. In particular, the autonomous software agent system 100 can use the large language model 314 to compare an embedding representation of the context of a current sub-task with embedding representations of activation triggers (e.g., context) in the secrets library 316. In doing so, the autonomous software agent system 100 can generate the artificial intelligence output which indicates the most relevant activation trigger or that there are no relevant activation triggers (e.g., within a relevance threshold).

In other words, the autonomous software agent system 100 can utilize the large language model 314 to compare the context of a current sub-task with a plurality of activation triggers (e.g., a plurality of contexts) in the secrets library 316. As shown, the autonomous software agent system 100 utilizes the large language model 314 to compare a context of the first sub-task 304 with a first relevant context 318, a second relevant context 320, and a third relevant context 322. Based on the comparison, the autonomous software agent system 100 can further use the large language model 314 to generate an output that points to a relevant activation trigger (e.g., with corresponding relevant access credential details from the secrets library 316).

In particular, the autonomous software agent system 100 can perform an act 324 of determining an applicable access credential for the first sub-task. In addition, FIG. 3 shows the autonomous software agent system 100 performing an act 328 of providing an applicable access credential 326 for the first sub-task 304 to the autonomous software agent 300.

In one or more embodiments, the autonomous software agent system 100 further causes the large language model 314 to transmit the artificial intelligence output to the autonomous software agent 300 executing the current sub-task. In doing so, the autonomous software agent system 100 then utilizes the autonomous software agent 300 to make a call to access a token corresponding to the activation trigger (e.g., as indicated by the artificial intelligence output) or the autonomous software agent does not access any tokens (e.g., if the artificial intelligence output indicates that there are no relevant activation triggers in the secrets library 316). In such cases, the autonomous software agent system 100 can prompt the user computing device to provide relevant secret details (e.g., access credentials). Accordingly, the autonomous software agent system 100 can iteratively perform this process of utilizing the large language model 314 to determine a relevant activation trigger for different sub-tasks of the software task 302.

FIG. 4 illustrates the autonomous software agent system 100 utilizing an autonomous software agent 402 that operates within an independent virtual machine computing environment 400 and further includes a large language model component 404. In particular, FIG. 4 shows the autonomous software agent system 100 executing a software task 406.

As shown in FIG. 4, the autonomous software agent system 100 performs an act 408 of detecting an activation trigger from executing the software task 406. Moreover, from performing the act 408 of detecting an activation trigger, the autonomous software agent system 100 further performs an act 410 of identifying a relevant access credential. In particular, FIG. 4 shows the autonomous software agent system 100 performing the act 410 of determining a relevant access credential by parsing/searching a secrets library 414 for the relevant access credential to execute the software task 406.

Moreover, FIG. 4 shows that the autonomous software agent system 100 performs the act 412 of determining that the relevant access credential should be redacted (e.g., based on a selection of a redaction option for the access credential). Furthermore, FIG. 4 shows that the relevant access credential corresponds to a confidential token 416 (e.g., based on detecting a selection of the redaction option).

As shown in FIG. 4, the autonomous software agent system 100 provides the confidential token 416 within computer environment variables 418. In one or more embodiments, the computer environment variables 418 refer to named key-value pairs maintained by an operating system that define configuration values and contextual information for running processes. In particular, the computer environment variables 418 refer to a standardized way to pass settings and state outside of application code, which allows programs to change behavior based on their execution environment. In other words, the computer environment variables 418 refer to system-managed configuration values that influence the behavior of software processes at runtime without requiring changes to source code.

In one or more embodiments, the autonomous software agent system 100 performs an act 420 of injecting the confidential token 416 into the computer environment variables 418 of the independent virtual machine computing environment 400 of the autonomous software agent 402. In particular, injecting the confidential token 416 into the computer environment variables 418 scrubs the confidential token 416 from being viewed by the large language model component 404 of the autonomous software agent 402. In other words, the confidential token 416 is redacted from a graphical user interface of the autonomous software agent 402 that mirrors actions taken by the autonomous software agent 402 and is further prevented from being accessed/viewed by the large language model component 404. As mentioned above, this prevents malicious actors and/or third-party applications from accessing the confidential token 416, which improves the overall security of implementing systems.

In one or more embodiments, injection of a token into computer environment variables occurs on-demand in response to detecting an activation trigger rather than preloading all eligible secrets at session initialization. The autonomous software agent system 100 materializes a decrypted token within volatile memory of the independent virtual machine computing environment only for the duration required to complete a corresponding sub-task. Upon completion of the sub-task, the autonomous software agent system 100 may revoke, unset, overwrite, or otherwise remove the environment variable to reduce persistence of sensitive material within the runtime environment.

In some embodiments, the autonomous software agent system 100 enforces a secret lifecycle state machine comprising states including stored, eligible, injected, active, revoked, and expired. State transitions may be triggered by session initialization, activation trigger detection, sub-task completion, expiration thresholds, or administrator action. The lifecycle state machine ensures that tokens are not persistently retained beyond their operational necessity.

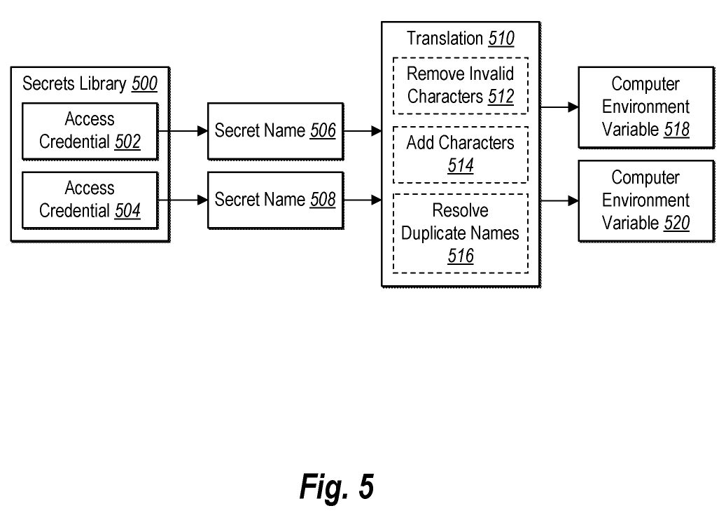

FIG. 5 illustrates the autonomous software agent system 100 performing a translation of secret names in accordance with one or more embodiments. For example, the autonomous software agent system 100 can perform text conversions to convert secret inputs into valid environment variables of an independent virtual machine computing environment.

As shown in FIG. 5, the autonomous software agent system 100 accesses a secrets library 500 containing at least an access credential 502 and an access credential 504. Furthermore, the autonomous software agent system 100 can access a secret name 506 corresponding to the access credential 502 and a secret name 508 corresponding to an access credential 504. Additionally, FIG. 5 shows the autonomous software agent system 100 performing an act 510 of translating the secret name 506 and the secret name 508.

In some embodiments, the act 510 of translating includes an act 512 of removing invalid characters, an act 514 of adding characters, and an act 516 of resolving duplicate names. For example, the autonomous software agent system 100 can remove invalid characters by replacing anything other than a letter, or digit, with an underscore. For example, if the secret name is Abc%123, the autonomous software agent system 100 can convert the secret name into an environment variable of Abc_123.

In some embodiments, if the secret name does not begin with a letter, the autonomous software agent system 100 can add an underscore to the beginning of the name. For example, the secret 123MYVAR can be translated into the environment variable of _123MYVAR. Additionally, if there are two secrets with the same name, the autonomous software agent system 100 can translate the secret names to add a counter to the end. For example, if the autonomous software agent system 100 contains two secrets named MY_SECRET, the autonomous software agent system 100 can generate two environment variables, MY_SECRET and MY_SECRET_2. Accordingly, the autonomous software agent system 100 can provide access to a user computing device via a preferred method of reading computer environment variables. For example, a user computing device can prepend a dollar sign to refer to a secret like $API_KEY.

Accordingly, FIG. 5 shows the autonomous software agent system 100 performing the act 510 of translating the secret name 506 and generating computer environment variable 518. Moreover, FIG. 5 shows the autonomous software agent system 100 performing the act 510 of translating the secret name 508 and generating computer environment variable 520 (e.g., based on the act 512 of removing invalid characters, the act 514 of adding characters, and the act 516 of resolving duplicate names).

FIG. 6 illustrates an overview of the autonomous software agent system 100 generating computer code by deploying an autonomous software agent in accordance with one or more embodiments. For example, FIG. 6 shows the autonomous software agent system 100 accessing/receiving a prompt 602. In particular, the prompt 602 refers to a natural language prompt 602a (from a user computing device), an application programming interface call 602b, and/or a tag/mention 602c in a messaging application.

In some embodiments, via an API, a user computing device can build custom workflows using the API of the autonomous software agent system 100 and programmatically assign tasks for the autonomous software agent system 100 to perform. Further, with the API, user computing devices can essentially plug in the autonomous software agent system 100 into any of their software development and internal tools.

In some embodiments, the autonomous software agent system 100 deploys an autonomous software agent in response to being triggered by a code editor. In particular, from another code editor/integrated development environment (IDE), user computing devices who use visual studio code (or visual studio code forks) can assign tasks to the autonomous software agent system 100 directly from their code editor/IDE.

In some embodiments, the autonomous software agent system 100 can deploy an autonomous software agent in response to being tagged/mentioned in a third-party messaging application. In particular, users of computing devices can tag the autonomous software agent system 100 directly from conversations they are having with colleagues in the third-party messaging application. Furthermore, the autonomous software agent system 100 will reply directly in the messaging thread and anyone can jump into the thread and provide further instructions to the autonomous software agent system 100.

In some embodiments, the autonomous software agent system 100 integrated with a third-party messaging application further includes a centralized server. In particular, the autonomous software agent system 100 utilizes a centralized server that is responsible for forwarding information between the autonomous software agent system 100 and the third-party messaging application. To illustrate, a user computing device can install a messaging integration for the autonomous software agent system 100 into a messaging workspace and further add the integration to the relevant channels of a messaging application.

In some embodiments, if the autonomous software agent system 100 receives a tag/mention of an autonomous software agent in the messaging application, then the autonomous software agent system 100 utilizes a centralized server to recognize the tag/mention. Furthermore, the autonomous software agent system 100 passes that tag/mention along to a web server backend that a website hosted by the autonomous software agent system 100 uses to start a new session (e.g., initiate an autonomous software agent for deployment).

As further shown in FIG. 6 and as discussed above, the autonomous software agent system 100 further accesses/receives knowledge 604. In particular, the knowledge 604 can include a development environment, guidelines, code repositories, and/or one or more software tasks from the knowledge library discussed above. In some embodiments, the knowledge 604 refers to a form of “memory” (e.g., memory inputs) that allows the autonomous software agent system 100 to retrieve information based on specific triggers that might be relevant to a session of the autonomous software agent. In some embodiments, the knowledge 604 can include a development environment, guidelines, code repositories, and a software task.

As further shown in FIG. 6, the autonomous software agent system 100 further performs an act 606 of deploying an autonomous software agent (e.g., a cloned virtual machine that is isolated and can perform tasks siloed from other devices). Moreover, as shown in FIG. 6, the autonomous software agent system 100 further provides to the autonomous software agent a shell tool 608, a browser tool 610, an integrated development environment 612 (e.g., editor), and a planner tool 614.

For example, a shell tool 608 refers to an interface layer that mediates interaction between an artificial intelligence (AI) agent and an underlying execution environment, computing system, development environment, or virtualized runtime. The shell tool 608 provides a structured command, control, and input/output framework through which the autonomous software agent system 100 issues instructions, receives responses, and orchestrates software development operations. A shell tool 608 may comprise a command-line interpreter, application programming interface (API) interface, remote procedure call (RPC) interface, messaging interface, terminal emulator, container interface, virtual machine interface, or any combination thereof. The shell tool 608 abstracts underlying system resources—including file systems, process control, compilers, interpreters, debuggers, network interfaces, and package managers—and presents a controllable operational surface to the autonomous software agent system 100.

As used herein, a browser tool 610 (or simply browser) refers to a software component executing within an independent virtual machine computing environment and configured to retrieve, render, interpret, and interact with network-accessible resources on behalf of an autonomous software agent system 100. A browser tool 610 operates as a controlled network interaction interface within the independent virtual machine computing environment and provides the autonomous software agent system 100 with programmatic access to web content, application interfaces, documentation repositories, APIs, development resources, and other remote computing services. A browser tool 610 may implement one or more communication protocols, including HTTP, HTTPS, WebSocket, or other network transport protocols.

In the context of the autonomous software agent system 100, a browser tool 610 may be configured to retrieve web pages, API responses, source code repositories, software documentation, or structured data from remote systems; render and parse markup languages including HTML, XML, Markdown, and script-generated content; execute client-side scripts in a sandboxed runtime; extract structured representations of document object models (DOMs), metadata, form fields, and interactive elements; submit forms, authenticate sessions, manage cookies or tokens, and maintain session state; download, upload, or modify remote resources under controlled permissions; provide machine-readable representations of rendered content to the autonomous software agent system 100 for reasoning and code generation; and enforce network policies, domain restrictions, rate limits, and security guardrails.

In some embodiments, a browser tool 610 is configured to expose structured outputs—such as DOM trees, accessibility trees, rendered text, event traces, console logs, or network traces—rather than or in addition to graphical output. A browser tool 610 may operate in headless mode and may be programmatically controlled via an automation interface.

A browser tool 610, as part of the independent virtual machine computing environment, is isolated from a host computing system and subject to resource constraints, execution monitoring, and security policies defined by the independent virtual machine computing environment. This isolation permits the autonomous software agent system 100 to perform research, dependency resolution, API inspection, automated testing of web applications, or code retrieval without exposing the host environment to uncontrolled network interactions. Unless expressly limited, a browser tool 610 encompasses any web client, headless browsing engine, embedded rendering engine, automated browsing framework, or network-interaction module configured to retrieve and interact with remote content within a virtualized execution environment controlled by the autonomous software agent system 100.

In some embodiments, the integrated development environment (IDE) 612 refers to an editor tool to write computer code and computer tests. In some embodiments, the integrated development environment 612 is a software application that brings together software tools for software development. In particular, the integrated development environment 612 refers to a software application that combines essential software development features (e.g., coding, debugging, testing, and deployment) to increase the efficiency of completing software projects. The IDE 612 may further maintain structured representations of a project state, including file hierarchies, dependency graphs, abstract syntax trees (ASTs), symbol tables, error diagnostics, execution traces, and build artifacts. In the context of the autonomous software agent system 100, the IDE 612 is configured to one or more software tasks; create, edit, refactor, or delete source files; invoke compilation or interpretation processes; execute unit tests or integration tests; surface compiler diagnostics and runtime errors; perform automated refactoring or formatting; manage branches and commits within a version control system; and return structured, machine-readable feedback to the autonomous software agent system 100 to enable iterative reasoning and code refinement.

In some embodiments, the integrated development environment 612 is a fully featured application that allows an autonomous software agent to write, test, and debug code without switching between different software applications. For example, the integrated development environment can include a code editor (e.g., syntax highlighting, code completion, etc.), a compiler/interpreter (e.g., converts source code into executable program code), a debugger (e.g., to find and fix computer code errors), a file browser (e.g., to navigate through files in a centralized development platform), version control (e.g., commit, push, pull, merge computer code in a code repository), and a terminal (e.g., direct command execution to run scripts or access computer system utilities).

In some embodiments, the autonomous software agent system 100 provides a code editor to the autonomous software agent, where the code editor is a sub-component of the integrated development environment. In other words, in some embodiments, the autonomous software agent system 100 provides a fully featured IDE that merges the functionalities of a code editor and the shell tool 608.

Accordingly, the autonomous software agent system 100 provides the autonomous software agent with its own IDE (e.g., independent of a computer code development environment of a user computing device that submitted the prompt 602) to perform software coding tasks. In other words, the autonomous software agent has full access to the integrated development environment 612, which enables the autonomous software agent to complete complex software development tasks.

In one or more embodiments, the planner tool 614 refers to an artificial intelligence model that analyzes a prompt 602 and plans how to execute one or more corresponding software tasks. In particular, the planner tool 614 breaks down a software task to manageable tasks and generates an artificial intelligence plan. In some embodiments, the autonomous software agent system 100 utilizes the planner tool 614 to generate the artificial intelligence plan and presents the artificial intelligence plan to a user computing device to modify or confirm one or more aspects in the artificial intelligence plan.

More specifically, that planner tool is configured to analyze one or more input objectives, user intents, or software task specifications and to generate structured, multi-step plans that guide operation of an autonomous software agent system 100 in performing code generation, modification, testing, analysis, or orchestration tasks. The planner tool 614 may be implemented using one or more underlying computational models, including but not limited to large language models (LLMs), transformer-based neural networks, sequence-to-sequence models, reinforcement learning models, probabilistic graphical models, symbolic reasoning engines, constraint solvers, heuristic search algorithms, or hybrid neuro-symbolic architectures. In one or more embodiments, planner tool 614 leverages a generative pretrained transformer model, including a code-capable language model, to infer task structure, identify implicit constraints, and predict ordered action sequences based on prior training across natural language corpora, source code repositories, execution traces, and software development workflows.

In one or more embodiments, the planner tool 614 is configured to decompose complex objectives into a sequence of actionable subtasks, determine dependencies and ordering among subtasks, and construct an execution plan consumable by downstream components such as code generation modules, debugging modules, the browser tool 610, the shell tool 608, IDE 612, testing frameworks, or other tool interfaces. The generated plan may comprise, without limitation, a hierarchical task tree, directed acyclic graph (DAG), ordered action list, state machine representation, or other structured plan representation including defined inputs, outputs, preconditions, postconditions, and success criteria.

In certain embodiments, planner tool 614 employs prompt-based reasoning, chain-of-thought inference, tree search, beam search, Monte Carlo sampling, reinforcement learning–based policy selection, or combinations thereof to evaluate multiple candidate plans and select or refine a plan according to defined optimization metrics. The planner tool 614 may further incorporate memory mechanisms, including contextual embeddings, vector databases, episodic execution logs, or persistent state representations, to inform plan generation based on prior interactions or historical outcomes. The planner tool 614 may monitor intermediate execution results and dynamically revise, re-order, expand, or prune subtasks based on feedback including compiler diagnostics, runtime errors, test failures, environmental changes, or external tool responses. In this manner, planner tool 614 supports iterative, adaptive, reactive, or predictive planning strategies. In some embodiments, the planner tool 614 operates as a distinct module that communicates with other components of autonomous software agent system 100 via structured messages, application programming interfaces (APIs), or message-passing protocols.

In one or more embodiments, the autonomous software agent system 100 utilizes the planner tool 614 to generate an artificial intelligence plan in accordance with one or more embodiments. In particular, the autonomous software agent system 100 accesses/receives the prompt 602 (e.g., from a user computing device). Furthermore, the autonomous software agent system 100 deploys an autonomous software agent to operate within an independent virtual machine computing environment.

As mentioned, the autonomous software agent system 100 utilizes the planner tool 614 to improve the efficiency and accuracy of executing a software task from the prompt 602. In some embodiments, the autonomous software agent system 100 utilizes the planner tool to generate a running “to do” list. In particular, the autonomous software agent system 100 can use the planner tool 614 to break down the prompt 602 and to infer one or more intents of the prompt 602. In one or more embodiments, the autonomous software agent system 100 utilizes the planner tool 614 to assist a user computing device in visualizing how the autonomous software agent (e.g., deployed by the autonomous software agent system 100) plans and thinks through solving a problem (e.g., as indicated in the prompt 602).

In some embodiments, the autonomous software agent system 100 utilizes a large language model (e.g., a planning model) to analyze the prompt 602. In one or more embodiments, the autonomous software agent system 100 utilizes the large language model that leverages retrieval-augmented generation (RAG) to generate an artificial intelligence plan. In some embodiments, retrieval-augmented generation refers to retrieving relevant information from an external database or an internal knowledge source (e.g., in the context of the prompt 602). In particular, the autonomous software agent system 100 can utilize RAG (e.g., which includes using the large language model) to generate a response (e.g., the artificial intelligence plan) by leveraging both the retrieved information (from an external source) and its own internal knowledge base. In particular, the autonomous software agent system 100 leverages RAG, which includes an input query, information retrieval, and response generation to perform a task of generating the artificial intelligence plan.

In some embodiments, the autonomous software agent system 100 further utilizes the large language model to perform an act of extracting a meta-task from the prompt 602. Moreover, as shown, the autonomous software agent system 100 performs an act of extracting intermediate tasks (e.g., sub-tasks) from the meta-task. In one or more embodiments, the autonomous software agent system 100 analyzes the prompt 602, determines an intent (e.g., a meta-task) of the prompt 602, and determines discrete sub-tasks (e.g., intermediate tasks).

In particular, the autonomous software agent system 100 can prompt the large language model to divide the prompt 602 into manageable and discrete sub-portions. In other words, the autonomous software agent system 100 prompts the large language model to identify tasks that point to different code repositories, data sources, and systems as being their own sub-task. In particular, the autonomous software agent system 100 can prompt the large language model and include example breakdowns of example requests.

Moreover, in some embodiments, the autonomous software agent system 100 trains the large language model with example datasets for breaking down a request into a meta-task and a plurality of sub-tasks. In particular, the autonomous software agent system 100 trains the large language model by having it generate a predicted artificial intelligence plan and then comparing the prediction to a ground truth reference.

In some embodiments, the autonomous software agent system 100 utilizes the large language model to generate an artificial intelligence plan to execute a software task. In particular, the autonomous software agent system 100 generates the artificial intelligence plan which includes a meta-task extracted from the prompt 602 and intermediate tasks extracted from the meta-task. In one or more embodiments, the autonomous software agent system 100 provides the artificial intelligence plan to a graphical user interface of a computing device. In particular, the autonomous software agent system 100 provides the artificial intelligence plan to receive approval or modification from a user computing device.

In one or more embodiments, the autonomous software agent system 100 can determine a relevant activation trigger based on the artificial intelligence plan. As discussed above, the autonomous software agent system 100 utilizes RAG to determine a relevant activation trigger (e.g., corresponding to an access credential/token) from the context of a sub-task. In some embodiments, the autonomous software agent system 100 extracts a meta-task and a plurality of sub-tasks from a software task indicated in the prompt 602. In doing so, the autonomous software agent system 100 can determine that a first sub-task indicates a first activation trigger (e.g., the first sub-task requires a token from a first access credential stored in a secrets library), a second sub-task indicates a second activation trigger (e.g., the second sub-task requires another token from a second access credential stored in a secrets library), etc.

In other words, in some instances, the autonomous software agent system 100 can identify relevant activation triggers from the artificial intelligence plan generated by the autonomous software agent system 100 via the planner tool 614. In some embodiments, the autonomous software agent system 100 can identify relevant activation triggers after the creation of an artificial intelligence plan (e.g., while an artificial intelligence plan is being executed by an autonomous software agent). In particular, the autonomous software agent system 100 detects a relevant activation trigger as it begins to get into the details of executing a software sub-task and then provides relevant access credential details to execute that software sub-task. In other words, the autonomous software agent system 100 determines a relevant activation trigger as the autonomous software agent system 100 encounters a sub-task that indicates the relevant activation trigger.

In some embodiments, the autonomous software agent system 100 can receive modifications to one or more tasks/sub-tasks and/or the meta-task extracted from the prompt 602. In some instances, the autonomous software agent system 100 can receive additional context or additional files to further customize the artificial intelligence plan. In some embodiments, the autonomous software agent system 100 receives one or more modifications to the artificial intelligence plan and generates a modified artificial intelligence plan.

Further, the autonomous software agent system 100 can prompt a user of a computing device to provide approval of the modified artificial intelligence plan. In response to receiving approval of an (updated) artificial intelligence plan, the autonomous software agent system 100 deploys the autonomous software agent to execute the prompt 602 according to the (updated) artificial intelligence plan.

Accordingly, in some embodiments, the autonomous software agent system 100 can modify its determination of relevant activation triggers based on one or more user inputs. In particular, the autonomous software agent system 100 can receive modifications to an artificial intelligence plan, and in response, detect additional relevant activation triggers or reverse previously detected activation triggers (e.g., as not relevant).

In some embodiments, the autonomous software agent system 100 utilizes the browser tool 610 to perform one or more actions responsive to prompt 602 to execute a software task. For example, the autonomous software agent system 100 accesses/receives the prompt 602. In one or more embodiments, the autonomous software agent system 100 utilizes the browser tool 610 to browse documentation on one or more website domain pages, test web applications (e.g., local applications), download information, upload information, etc. In particular, the autonomous software agent system 100 utilizes the browser tool 610 to perform a first navigation step, a second navigation step, and a third navigation step on a website page.

In one or more embodiments, a website page (e.g., a website domain page) refers to a webpage hosted under a domain name that serves as an entry point of a website and is identified by a URL. For example, a website page refers to a digital webpage associated with a domain name that has a unique URL and contains structured content (e.g., text, images, links, and other media). In particular, a website page is part of a larger website hierarchy. To illustrate, a website hierarchy includes a homepage, subpages, and subdomain pages. In some embodiments, a plurality of website pages is associated with an entity.

In one or more embodiments, the autonomous software agent system 100 utilizes the browser tool 610 to obtain information from a website page. In some embodiments, the autonomous software agent system 100 determines whether a particular portion of a website page is relevant to the prompt 602 to execute a software task. In particular, the autonomous software agent system 100 utilizes a large language model (e.g., a website relevance model) to determine the relevance of a sub-portion, portion, or entire website page.

In other words, website pages contain an excessive amount of information. In particular, large language models are typically bogged down with processing all elements within a website page. Thus, the autonomous software agent system 100 distills a website page structure (e.g., utilizing the large language model) and provides a simplified structure (e.g., HTML) to the autonomous software agent for further processing. In doing so, the autonomous software agent system 100 enables the autonomous software agent to process a large amount of data from website pages without performance degradation.

In some embodiments, the autonomous software agent system 100 utilizes the large language model to perform an act of determining a document object model (DOM) of a website page. In particular, the autonomous software agent system 100 passes a website page to the large language model to determine a document object model of the website page.

In one or more embodiments, a document object model refers to a structured, hierarchical representation of a webpage’s content that defines how HTML elements are programmatically accessed, modified, and analyzed. In one or more embodiments, the autonomous software agent system 100 detects a document object model object within a website page. For example, the DOM includes a representation of structure, content and properties within a website page. For instance, a user of a website domain interacts with and manipulates a DOM object. Further, in some embodiments the DOM includes HTML or XML format. Accordingly, the DOM includes references to specific elements or nodes within the website domain page. To illustrate, DOM objects are part of a DOM tree structure, where each node of the DOM tree structure corresponds to a specific element in a website page.

In some embodiments, the autonomous software agent system 100 utilizes the large language model to perform an act of identifying relevant document object model elements (e.g., DOM elements). In particular, the autonomous software agent system 100 prompts the large language model to identify relevant DOM elements in the context of the prompt 602. In other words, the autonomous software agent system 100 utilizes the large language model to distill a website page into a relevant set of elements for the prompt 602.

In some embodiments, the autonomous software agent system 100 utilizes the large language model to generate a simplified DOM tree (e.g., a simplified document object model tree). As mentioned above, in some instances, a website page contains a large amount of data that can potentially bog down computational processes. As such, the autonomous software agent system 100 utilizes the large language model to extract the most salient/relevant elements from a website page (e.g., being browsed via the browser tool 610) and generates the simplified DOM tree.

In one or more embodiments, the simplified DOM tree refers to a distilled document object model structure and/or a distilled hierarchical representation of a webpage’s content. In particular, the simplified DOM tree includes a hierarchy of nodes and elements from the website page that are relevant to the prompt 602. In other words, the simplified DOM tree contains fewer website page elements relative to an initially determined DOM tree from the website page.

In one or more embodiments, the autonomous software agent system 100 can utilize the simplified DOM tree as contextual data of a website page and determine whether there is a relevant activation trigger in the secrets library. For example, as discussed above, the autonomous software agent system 100 can detect relevant activation triggers by transmitting contextual data and a large language model relevance prompt to a large language model. In particular, the autonomous software agent system 100 can transmit the simplified DOM tree (e.g., which captures relevant elements) and a prompt to a large language model to determine whether there are any relevant activation triggers. In other words, the autonomous software agent system 100 can determine (e.g., while using a website browser) whether there are any tasks relevant to the prompt 602 that require an access credential stored within the secrets library.

In some embodiments, the autonomous software agent system 100 utilizes the shell tool 608 to generate one or more terminal commands. In one or more embodiments, the shell tool 608 refers to one or more terminals (e.g., one or more terminal windows). In particular, the autonomous software agent system 100 deploys the autonomous software agent that can create new terminal windows or switch to different terminal windows, or delete terminals (e.g., which is how an autonomous software agent can run multiple processes at once). For relatively long commands, the autonomous software agent system 100 can use the autonomous software agent to shift its attention away from the long-running command and multitask in parallel (e.g., via the shell tool 608).

In some embodiments, the shell tool 608 is a text-based application where the autonomous software agent can input commands that interact directly with a computer’s operating system. In particular, the autonomous software agent system 100 spins up the autonomous software agent that includes a shell application and in the shell application there are different terminals. As mentioned, where each terminal is like a single terminal window, the autonomous software agent system 100 (e.g., via the autonomous software agent) has the ability to create new terminals, switch to different terminal windows or delete terminals.

Furthermore, the autonomous software agent system 100 performs an act of utilizing the autonomous software agent to generate terminal commands. In one or more embodiments, a terminal command refers to text instructions to instruct a computer’s operating system. In particular, a terminal command refers to one-line instructions that typically call upon existing programs of an operating system.

In some embodiments, a terminal command refers to text-based instructions submitted/inputted into a terminal (e.g., the terminal is an interface that allows computing devices such as the autonomous software agent to interact with a computer system’s underlying operating system or run scripts and programs directly). To illustrate, terminal commands can include file and directory navigation, file operations, viewing file contents, searching and filtering, processes and systems in an operating system, determining permissions and ownerships in an operating system, and networking.

Moreover, the autonomous software agent system 100 generates command outputs. In one or more embodiments, command outputs refer to outputs that correspond with terminal commands submitted via the shell tool 608. To illustrate, a command output can include an absolute path (e.g., in response to a command to determine a location), tabular text (e.g., in response to a command to list files), raw file text (e.g., in response to a command to print file contents), an interactive viewer (e.g., in response to a command to provide a paged output), an output pattern (e.g., in response to a command to search/filter files in an operating system), and a file path (e.g., in response to a command to locate files).

Accordingly, the autonomous software agent system 100 utilizes the autonomous software agent to execute a software task (e.g., indicated by the prompt 602) by using the shell tool 608. In particular, the autonomous software agent system 100 determines a plurality of sub-tasks for a meta-task indicated in the prompt 602, generates an artificial intelligence plan, and utilizes the shell tool to execute one or more of the sub-tasks (e.g., by submitting terminal commands).

In some embodiments, the autonomous software agent system 100 receives a selection of a shell feature and opens/launches an interactive shell of the autonomous software agent. In particular, the autonomous software agent system 100 causes a graphical user interface (e.g., of a user computing device) to show shell activity (e.g., terminal commands or outputs corresponding to terminal commands) of the autonomous software agent utilizing the shell tool 608 while independently performing the software task. Accordingly, the user computing device (e.g., via the graphical user interface) can intervene (e.g., take over) the autonomous software agent’s shell and push a software task in a different direction.

In one or more embodiments, the autonomous software agent system 100 determines a relevant activation trigger based on terminal commands or terminal command outputs. In particular, the autonomous software agent system 100 utilizes an autonomous software agent to execute a sub-task by submitting terminal commands/generating terminal command outputs and determines a relevant activation trigger. In particular, the autonomous software agent system 100 transmits contextual data of the shell tool 608 and a large language model relevance prompt to a large language model to determine whether there is a relevant activation trigger for the current sub-task.

Moreover, in some embodiments, the autonomous software agent system 100 determines a relevant activation trigger based on a user computing device intervening within the shell tool 608. In other words, a user computing device may push a software task in a different direction, and in response, the autonomous software agent system 100 determines a relevant activation trigger from the secrets library.

In one or more embodiments, the autonomous software agent system 100 utilizes an integrated development environment to generate computer code in accordance with one or more embodiments. For example, the autonomous software agent system 100 accesses/receives a request and deploys an autonomous software agent. In particular, the autonomous software agent system 100 deploys the autonomous software agent to operate within an independent virtual machine computing environment.

Moreover, the autonomous software agent system 100 provides the integrated development environment 612 (IDE tool) to the autonomous software agent. In one or more embodiments, the integrated development environment 612 of the autonomous software agent includes an editor (e.g., in some embodiments, the autonomous software agent utilizes multiple editor tabs which represent open files in an editor area of the IDE for writing/editing computer code). In particular, the editor corresponds to an open file.

As mentioned above, the autonomous software agent has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task.

In some embodiments, the autonomous software agent system 100 utilizes the integrated development environment 612 to perform an act of generating computer code. In some embodiments, computer code includes a set of instructions written in a programming language that a computing device can interpret and execute to perform a specific task. In particular, computer code includes a series of statements and functions that execute specific operations. Further, computer code includes statements written in specific syntax and translatable into machine code to be executed by a computing device.

Further, computer code can include function code and test code. In some embodiments, function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

In some embodiments, test code refers to computer code that defines a function test for function code. For example, test code can include one or more code segments for determining that the function code satisfies an intent query. In some cases, the autonomous software agent system 100 utilizes test code to test function code. For example, the autonomous software agent system 100 generates the test code that includes computer code for testing whether the output of function code satisfies an intent query. In some embodiments, test code can also test for different types of errors (e.g., syntax errors and logic errors) and/or for hazardous or harmful function code.

In some embodiments, the computer code includes executable program code which refers to a set of instructions that a computing device can directly execute. In particular, executable program code includes machine-readable instructions that result from compiling high-level programming languages. In other words, executable program code refers to a final output for a software development process created by compiling source code.

As noted above, in one or more embodiments, the autonomous software agent system 100 provides actions performed by the autonomous software agent to a graphical user interface of a user (e.g., a user computing device). In particular, in the context of the integrated development environment 612, the autonomous software agent system 100 can provide to a graphical user interface real-time actions and/or actions performed during a development session of the autonomous software agent utilizing the integrated development environment 612.

In some embodiments, the autonomous software agent system 100 can receive an input selection that relates to a user computing device indicating a desire to modify one or more inputs in the integrated development environment 612. Further, in some embodiments, the autonomous software agent system 100 can receive an input selection to follow the autonomous software agent (e.g., in real-time) as the autonomous software agent executes a software task indicated by the prompt 602.

In some embodiments, the autonomous software agent system 100 provides for display the integrated development environment 612 that includes the above-mentioned editor tab. Further, in some instances, the autonomous software agent system 100 also provides a problems tab which lists errors, warnings, and information for computer code (in the editor tab) for a user to efficiently see errors in computer code or jump to problematic portions of computer code), an output tab (e.g., shows logs and messages from the IDE or extensions of the IDE to be notified of background activities like loading data onto a server or plugin operations), a debug console (e.g., allows for interactions with a program during debugging, such as viewing runtime logs, evaluating expressions, or inspecting variables), a terminal (e.g., a built-in shell/command-line interface for executing/submitting commands to a terminal, such as running scripts or installing packages), and a version control tab (e.g., provides information as to which devices submitted changes to a code repository and why the changes were submitted to a code repository).

In one or more embodiments, the autonomous software agent system 100 detects a relevant activation trigger as the autonomous software agent is utilizing the integrated development environment 612. In particular, the autonomous software agent system 100 transmits contextual data of the integrated development environment 612 and a large language model relevance prompt to a large language model to determine a relevant activation trigger (if any).

In some embodiments, as the autonomous software agent writes computer code in the integrated development environment 612, the autonomous software agent determines that specific access credentials are required to continue executing the software task. However, after transmitting the context and a large language model prompt to a large language model, the autonomous software agent system 100 determines that there are no relevant activation triggers in the secrets library. In such cases, the autonomous software agent system 100 directly prompts a user computing device to provide the relevant access credentials (e.g., secret details). Moreover, in some embodiments, the autonomous software agent system 100 also prompts the user computing device to save the relevant access credentials in the secrets library.

As shown in FIG. 6, the autonomous software agent system 100 utilizes the autonomous software agent to generate artificial intelligence output(s) 616 based on the prompt 602. In particular, the autonomous software agent system 100 utilizes the autonomous software agent to access the plurality of software composition tools (e.g., the shell tool 608, the browser tool 610, the integrated development environment 612, and/or the planner tool 614) and generates the artificial intelligence output(s) 616.

More specifically, in one or more embodiments, the autonomous software agent system 100 is configured to automatically (e.g., without further user instructions other than the prompt defining the software task) perform an assigned software task using coordinated interaction among planner tool 614, browser tool 610, an integrated development environment (IDE) 612, a shell tool 608, and an independent virtual machine computing environment. For example, upon receiving a software task—expressed in natural language, structured specification, source code fragment, test case, or other machine-interpretable format—the autonomous software agent system 100 provides the software task to planner tool 614. The planner tool 614 analyzes the objective and generates a structured execution plan comprising an ordered set of subtasks, dependency relationships, required tools, expected outputs, and validation criteria. The execution plan may define actions such as retrieving documentation, generating source code, creating files, compiling code, executing tests, debugging failures, refactoring modules, or deploying artifacts. The autonomous software agent system 100 executes the structured plan within the independent virtual machine computing environment. Where plan steps require external information or dependency retrieval, the autonomous software agent system 100 invokes the browser tool 610 within the independent virtual machine computing environment. The autonomous software agent system 100 uses the browser tool 610 to retrieve and parse remote documentation, API specifications, repositories, or other network-accessible resources and returns structured, machine-readable representations to autonomous software agent system 100 for reasoning and code synthesis.

For code authoring and modification operations, the autonomous software agent system 100 interacts with the IDE 612. The IDE 612 enables creation, editing, refactoring, and organization of source files, as well as invocation of compilers, interpreters, build systems, static analysis tools, and test frameworks. The IDE 612 provides structured diagnostics, including syntax errors, semantic warnings, dependency conflicts, and build logs, which are returned to autonomous software agent system 100. Where system-level commands are required, autonomous software agent system 100 issues instructions through the shell tool 608 executing within the independent virtual machine computing environment. The shell tool 608 enables file system manipulation, dependency installation, build execution, test invocation, process control, and other operating system–level operations. Structured outputs including exit codes, logs, and error streams are returned to autonomous software agent system 100.

The planner tool 614, in one or more implementations, monitors intermediate results generated by the IDE 612, browser tool 610, and shell tool 608, and compares those results against plan-defined success criteria. If discrepancies, failures, or unexpected states are detected, the planner tool 614 automatically revises the execution plan, generates corrective subtasks, reorders actions, or initiates debugging procedures. This iterative loop continues until the software task satisfies defined completion conditions or termination criteria. In this manner, autonomous software agent system 100 autonomously decomposes, executes, validates, and refines development actions within the independent virtual machine computing environment using coordinated tool invocation and structured feedback processing. The integration of planner tool 614, browser tool 610, the 612, the shell tool 608, and the independent virtual machine computing environment enables end-to-end automated software development, testing, and validation without direct human intervention.

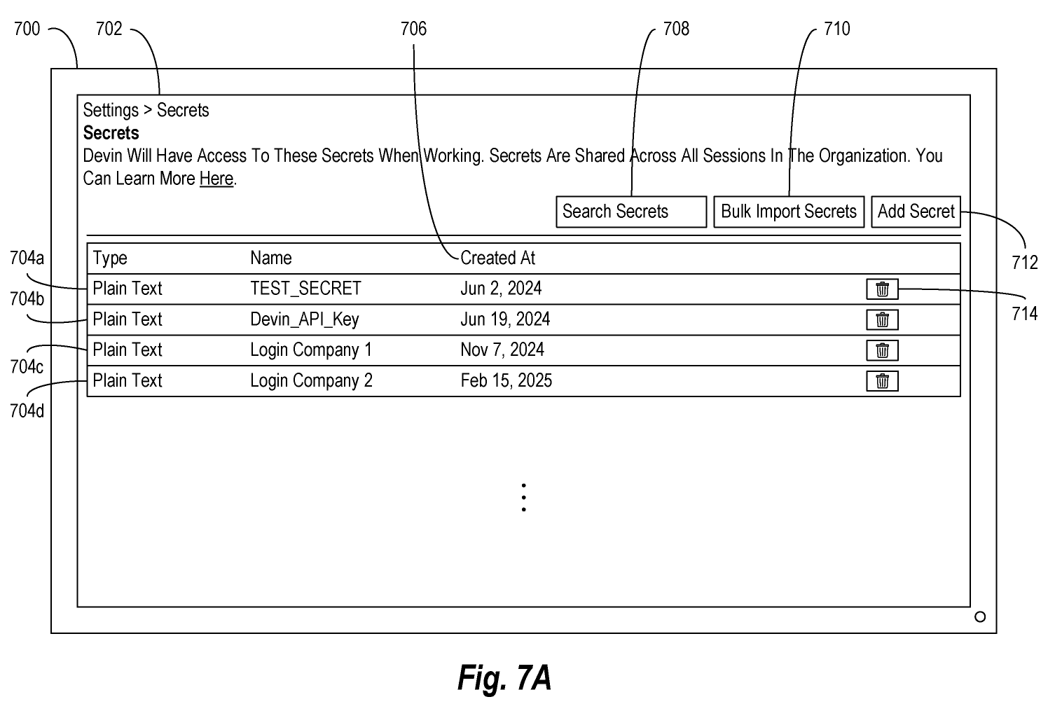

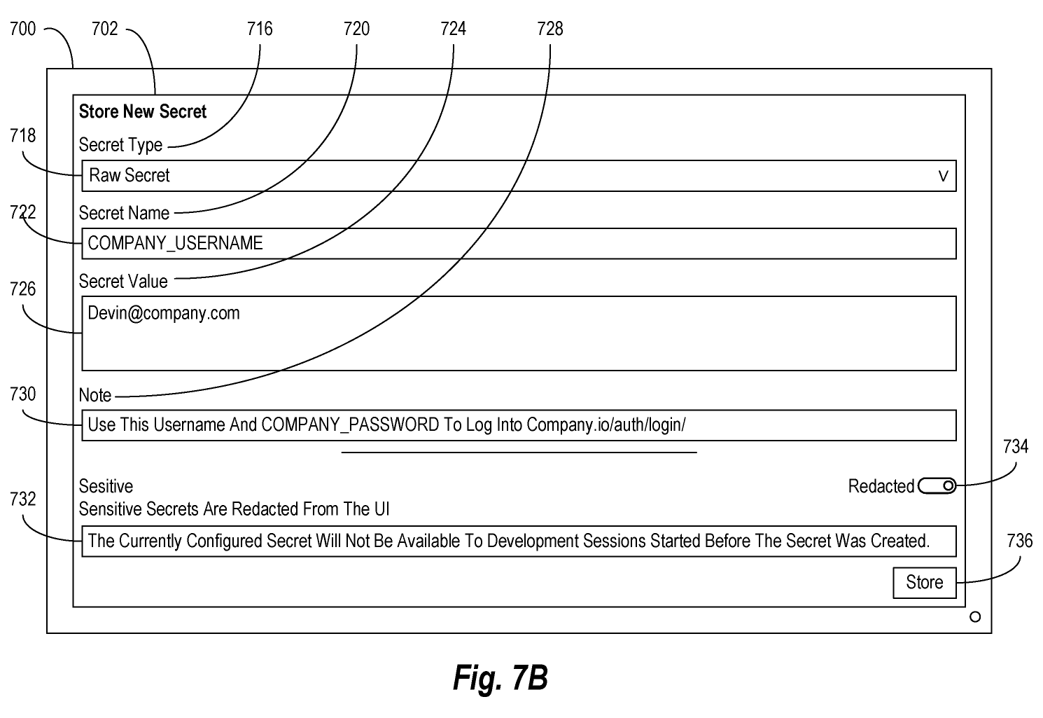

FIG. 7A illustrates the autonomous software agent system 100 providing a secrets interface to a user computing device in accordance with one or more embodiments. For example, FIG. 7A shows the autonomous software agent system 100 providing via a graphical user interface 702 of a user computing device 700 a plurality of access credentials. In particular, FIG. 7A shows a first access credential 704a, a second access credential 704b, a third access credential 704c, and a fourth access credential 704d.

As shown in FIG. 7A, the first access credential 704a corresponds to a secret name of TEST_SECRET, the second access credential 704b corresponds to a secret name of Devin_API_Key, the third access credential 704c corresponds to a secret name of Login company 1, and the fourth access credential 704d corresponds to a secret name of Login company 2.

Moreover, FIG. 7A shows a created at column 706 to indicate a date of creation for each of the access credentials. Additionally, FIG. 7A shows a search secret element 708 to filter the plurality of secrets (e.g., access credentials). Moreover, FIG. 7A shows a bulk import secret element 710 to import a document of additional access credentials. Further, FIG. 7A shows an individual secret element 712 to add an individual secret and a remove secret element 714 to delete a secret.

FIG. 7B shows the autonomous software agent system 100 providing an interface to create an individual secret. For example, FIG. 7B shows a secret type 716 with a secret type input 718 of raw secret. Further, FIG. 7B shows a secret name 720 with a secret name input 722 of COMPANY_USERNAME. Additionally, FIG. 7B shows a secret value 724 (e.g., a token) with a secret value input 726 of devin@company.com. Moreover, FIG. 7B shows a note 728 (e.g., context that can correspond to an activation trigger) and a note input 730 that reads “use this username and COMPANY_PASSWORD to log into company.io/auth/login/.”

Moreover, FIG. 7B shows guidance instructions 732 that read: the currently configured secret will not be available for development sessions started before the secret (e.g., access credential) was created. In addition, FIG. 7B shows a redaction option and a selection 734 of the redaction option. As discussed above, in response to the selection 734 of the redaction option, the autonomous software agent system 100 scrubs the secret value 724 (e.g., token) from being viewed/accessed by a large language model component (e.g., or any third-party models) of an autonomous software agent executing a software task. Moreover, FIG. 7B shows a store element 736 to save the configured access credential.

In one or more embodiments, the autonomous software agent system 100 further implements a multi-layer redaction pipeline configured to prevent exposure of confidential tokens across tool interfaces. The redaction pipeline intercepts output streams generated by the shell tool 608, browser tool 610, integrated development environment 612, and execution replay module prior to presentation within a graphical user interface or storage within logging systems.

The redaction pipeline may include a token-matching engine that performs pattern-based detection of secret values and replaces detected substrings with masked representations before logs are persisted or displayed. In some embodiments, the autonomous software agent system 100 applies redaction to terminal command outputs, browser network traces, document object model captures, console logs, execution replay recordings, and development session transcripts. Accordingly, even if a runtime process outputs a secret value, the autonomous software agent system 100 prevents exposure to user interfaces, stored logs, or downstream large language model prompts.

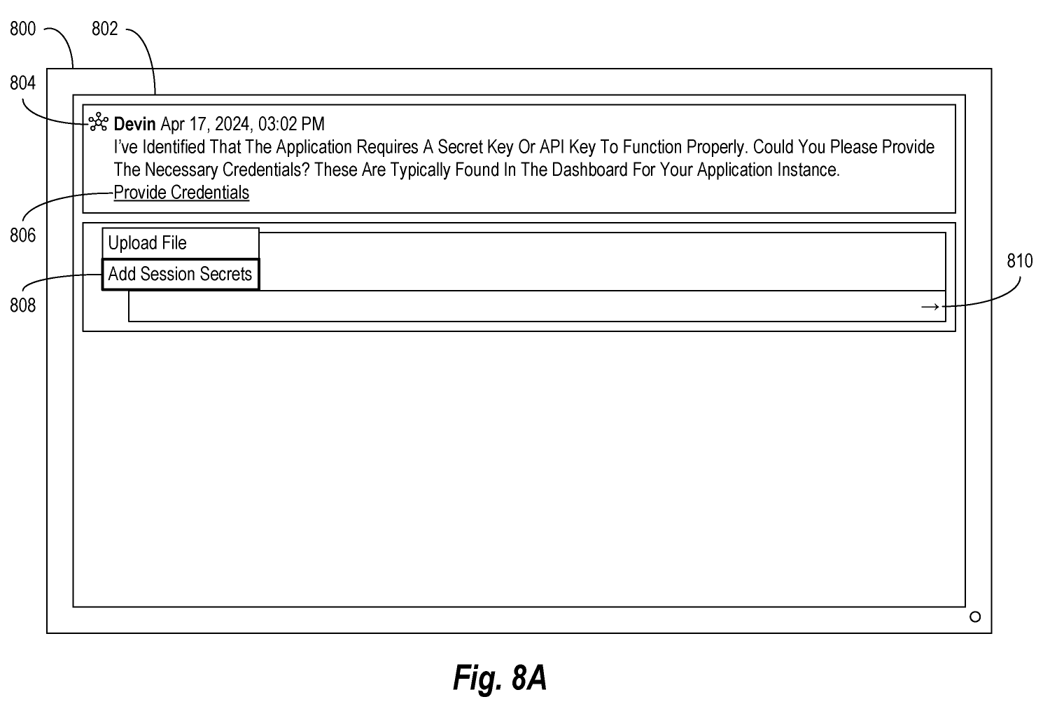

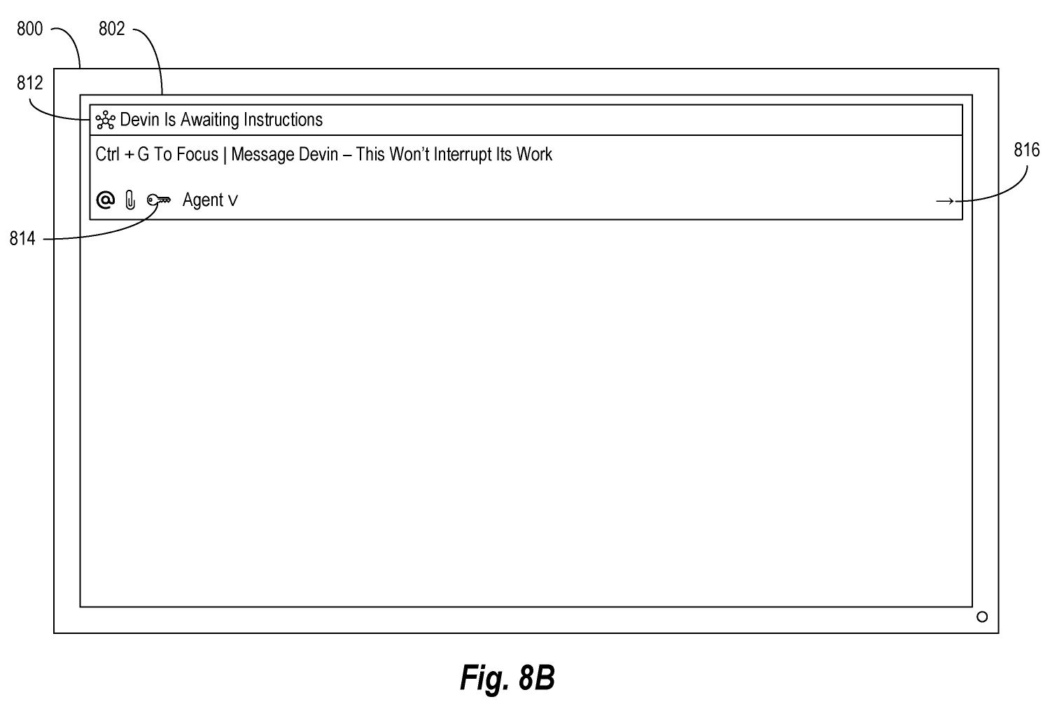

FIG. 8A shows the autonomous software agent system 100 prompting a user computing device 800 during execution of a software task via a graphical user interface 802. In particular, FIG. 8A shows a message 804 from the autonomous software agent system 100 that reads “I’ve identified that the application requires a secret key or API key to function properly. Could you please provide the necessary credentials? These are typically found in the dashboard for your application instance.”

Moreover, FIG. 8A shows a provide credential element 806. In particular, in response to a selection of the provide credential element 806, a user computing device can submit the credentials. Furthermore, FIG. 8A shows that the graphical user interface 802 can display an interface for the user computing device 800 to interact with an add session secret element 808. Moreover, FIG. 8A shows a submission element 810 to submit an added session secret. FIG. 8B shows a status 812 of the autonomous software agent system 100 awaiting instructions from the user computing device 800. In particular, FIG. 8B shows a send secret element 814 for the user computing device 800 to submit secrets and a submission element 816 to submit the secrets.

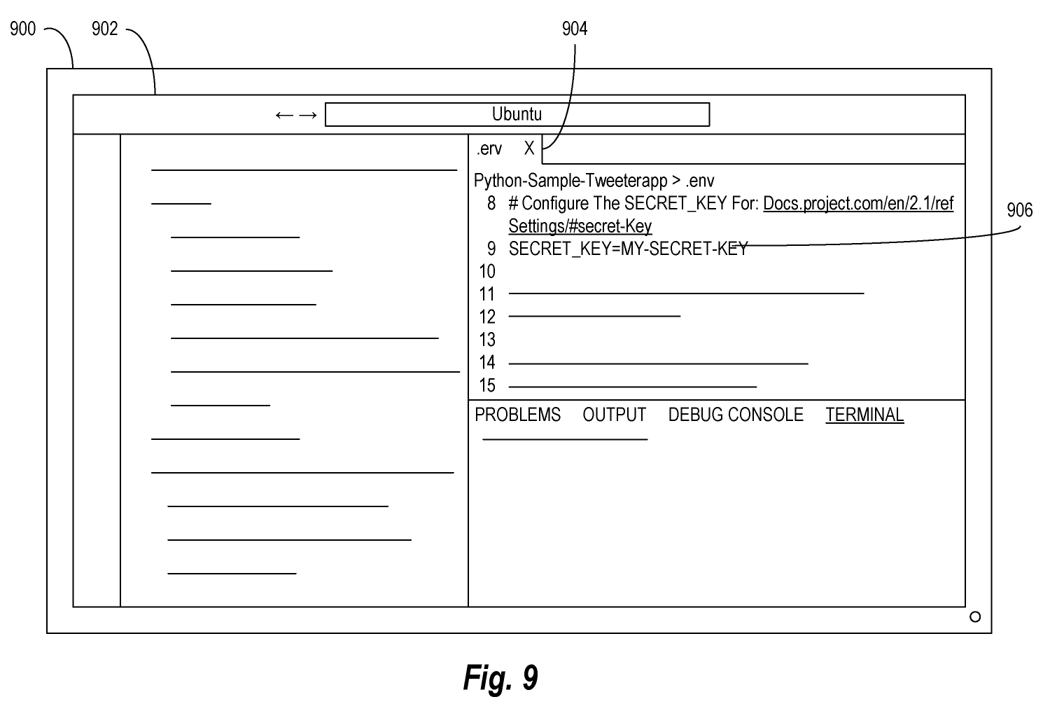

As discussed above, the autonomous software agent system 100 can receive repository-specific secrets. In particular, the autonomous software agent system 100 can receive access credentials scoped to a specific code repository. For example, FIG. 9 shows a graphical user interface 902 of a user computing device 900 with an opened tab 904 (e.g., .env). In particular, FIG. 9 shows that the autonomous software agent system 100 receives a repository-specific secret 906 as it is added as an environment variable. In particular, FIG. 9 shows a comment of # Configure the SECRET_KEY for: docs.project.com/en/2.1/ref/settings/#secret-key. Additionally, FIG. 9 shows the repository-specific secret 906 as “SECRET_KEY=MY-SECRET-KEY.”

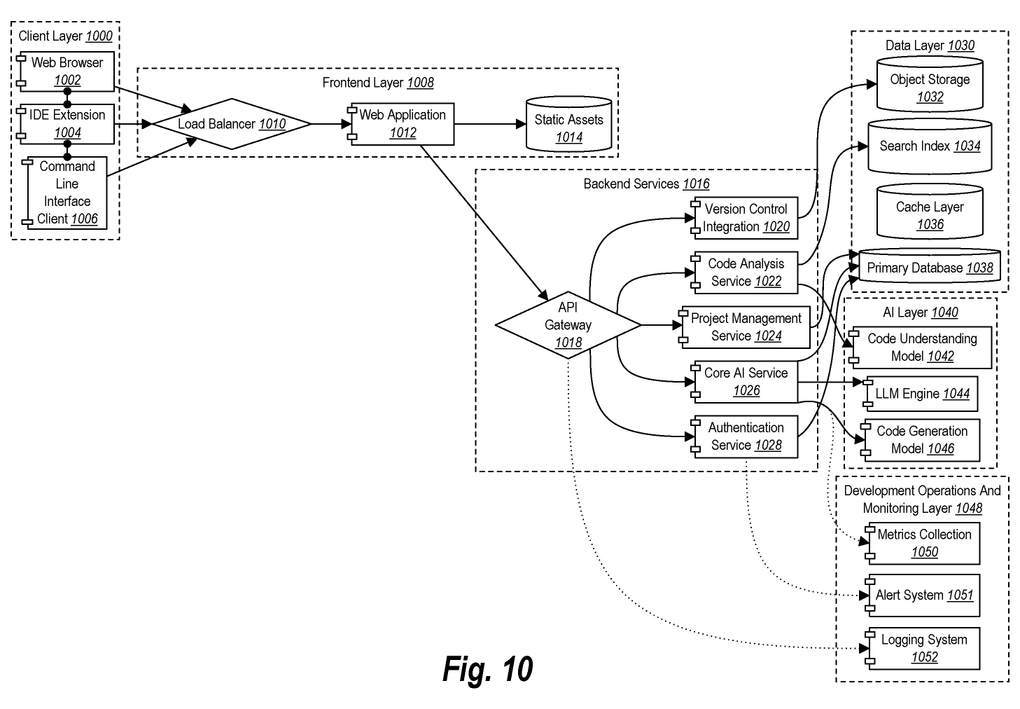

FIG. 10 illustrates architectural details of the autonomous software agent system 100 using one or more machine learning models in accordance with one or more embodiments. In particular, the autonomous software agent system 100 deploys an autonomous software agent with a plurality of computer software composition tools, generates one or more artificial intelligence outputs responsive to a software task, and provides responses to prompts submitted via an interface.

As shown in FIG. 10, the autonomous software agent system 100 contains a client layer 1000 (e.g., with a web browser 1002, an IDE extension 1004, and a command line interface client 1006), a frontend layer 1008 with a load balancer 1010 (e.g., which is a system to distribute incoming traffic across multiple servers which optimizes efficiency), a web application 1012 (e.g., a Devin web application that shows a chat interface and the fully featured software composition tools of the autonomous software agent), and static assets 1014 (e.g., files that do not dynamically change based on user interactions, such as HTML files, CSS files, JavaScript files, images, etc.).

Moreover, FIG. 10 shows the autonomous software agent system 100 also contains backend services 1016 with an API gateway 1018 (e.g., which is a single entry point for managing and routing API requests from client devices to different microservices/backend systems), a version control integration 1020 (e.g., a backend service application to track changes to code such as a connected code repository application part of a code repository management system), a code analysis service 1022, a project management service 1024 (e.g., a software system to track the development of various tasks that a software development team is working on), a core AI service 1026 (e.g., artificial intelligence modules or tools to handle the use of machine learning models, natural language processing, and other artificial intelligence tasks), and an authentication service 1028 (e.g., to check for valid authentication credentials).

In particular, the backend services 1016 include applications that all communicate with the backend web-server of the autonomous software agent system 100, which performs the job of deploying autonomous software agents, and orchestrating/managing sessions (Devin sessions), as well as providing the APIs to display data about the autonomous software agent system 100 on various computing devices, generating artificial intelligence outputs, orchestrating the execution of software tasks by accessing a plurality of software composition tools, providing a plurality of interactive tools to a user computing device. In particular, the backend services 1016 of the autonomous software agent system 100 manage the generation of artificial intelligence outputs for executing a software task of a development session.

For example, the backend services 1016 perform the job of enabling request decomposition, artificial intelligence plan generation, terminal command generation, computer code generation, navigation actions, software task orchestration, and interactive tools of the autonomous software agent. In particular, the client layer 1000, the frontend layer 1008 and the backend services 1016 are in consistent communication with one another to notify each service regarding any input received from a user computing device (e.g., via a chat interface and/or user intervention via interactive tools). Thus, this enables the autonomous software agent system 100 to immediately transfer that input/context to a deployed autonomous software agent.

Further, FIG. 10 shows a data layer 1030 with object storage 1032 (e.g., which is storage of unstructured data), a search index 1034 (e.g., an index of one or more code repositories), a cache layer 1036 (e.g., a layer that temporarily holds frequently accessed or recently computed data), and a primary database 1038 (e.g., a central data store to hold application data). Moreover, FIG. 10 shows an AI layer 1040 with a code understanding model 1042, an LLM engine 1044, and a code generation model 1046. Moreover, FIG. 10 shows a development operations and monitoring layer 1048 (e.g., with metrics collection 1050, an alert system 1051, and a logging system 1052).

As shown in FIG. 10, the autonomous software agent system 100 utilizes the AI layer 1040 to perform a variety of reasoning/generation tasks. In particular, the autonomous software agent system 100 accesses the AI layer 1040 every time a code repository is connected or updated, or a new session is spun up (e.g., each time a new development box is activated). In order to enable the AI layer 1040, the autonomous software agent system 100 provides various onboarding tools to a user computing device. In particular the onboarding tools allow a user to provide access to a code repository provider (e.g., a Gitprovider), select repositories, assign read access, and assign write access.

In some embodiments, the autonomous software agent system 100 prompts a user computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 10, the AI layer 1040 of the autonomous software agent system 100 further includes the code understanding model 1042. In particular, the code understanding model 1042 analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model 1042. To illustrate, the autonomous software agent system 100 parses through a code repository and generates abstraction summaries using the code understanding model 1042 and one or more additional artificial intelligence models (e.g., such as the LLM engine).

Moreover, the autonomous software agent system 100 utilizes the AI layer 1040 to enable AI-native features in a planner interface, a chat interface, or a configuration interface of an autonomous software agent. In particular, the autonomous software agent system 100 provides the AI-native features as options for a user computing device to activate during configuration or during interaction with the autonomous software agent system 100.

In some embodiments, the autonomous software agent system 100 uses the AI layer 1040 to ingest data from a code base and further utilizes the code understanding model 1042 to generate output predictions related to the context of the code base. For example, the autonomous software agent system 100 connects to code repositories and creates knowledge inputs/suggestions based on processing the information in the code repository.

To illustrate, the autonomous software agent system 100 can read through documentation/specifications and distill that information into data that is relevant for the code understanding model 1042 of the autonomous software agent system 100. In addition, after generating the index of the code repository, the autonomous software agent system 100 further stores the index in the data layer 1030 and/or uses the development operations and monitoring layer 1048 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates a response to prompts. In some embodiments, the autonomous software agent system 100 receives prompts from the frontend layer 1008 submitted via an interface (or where the autonomous software agent system 100 intakes a prompt, whether via the web application, a messaging application, or otherwise) and they are sent to the backend services 1016 of the autonomous software agent system 100, where the prompt is processed by the one or more artificial intelligence components (e.g., Devin’s brain).

As shown in FIG. 10, the autonomous software agent system 100 utilizes the client layer 1000 to receive interactions. In particular, users can submit a prompt or a question regarding a current development session, past development session, a code repository, etc. via a Devin messaging application integration, an application programming interface call, or directly through a web browser application of the intelligent search interface. In some embodiments, the messaging application integration lets users prompt the autonomous software agent system 100 and further create sessions by tagging an autonomous software agent in their team’s messaging server.

As just mentioned, the messaging application integration allows for development sessions to be created by tagging/mentioning an autonomous software agent. In some embodiments, the autonomous software agent system 100 receives from a third-party messaging application between a plurality of users, a mention that tags the autonomous software agent to execute the software task. Additionally, the autonomous software agent system 100 transmits the mention that tags the autonomous software agent to a virtual private cloud that hosts the independent virtual. This is shown in more detail below.

In some embodiments, as shown, the autonomous software agent system 100 utilizes the LLM engine 1044 (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 10. In particular, the autonomous software agent system 100 includes a natural language processing component (e.g., Devin’s Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in Application No. 19/224,222 PROVIDING INTELLIGENT SEARCH FUNCTIONALITY OF A CODE REPOSITORY VIA AN AUTONOMOUS SOFTWARE AGENT which was filed on May 30^{th}, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun-up development box contains knowledge and the autonomous software agent system from one session to another does not transfer the knowledge over to the next session. In some embodiments, knowledge is a form of “memory” that allows the autonomous software agent system 100 to retrieve information based on specific triggers that might be relevant to the session. As also mentioned, this knowledge (depending on the trigger) is retrievable across all sessions.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a browser, etc.). Moreover, the autonomous software agent system 100 allows a development box to be customized in a user’s workspace (e.g., Devin’s Workspace), where the user can save a specific machine snapshot that the autonomous software agent system 100 will use each time it spins up a new development box.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled back to an earlier point in time. In rolling back to an earlier point in time, the autonomous software agent system 100 rolls back both the state of “Devin’s brain” (e.g., the knowledge and the progress on a certain task), as well as the state of Devin’s machine (e.g., the machine contents).

Moreover, in some embodiments, the autonomous software agent system 100 offers a virtual private cloud (VPC) deployment solution that allows development boxes to run within a customer’s (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 1040, the data layer 1030, the backend services 1016, and the frontend layer 1008 to cause the graphical user interface on the user computing device to display the actions taken by the autonomous software agent (e.g., the actions via the software composition tools of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into artificial intelligence outputs (e.g., artificial intelligence plans, computer code, terminal commands, navigation actions, etc.). Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes the code generation model 1046. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

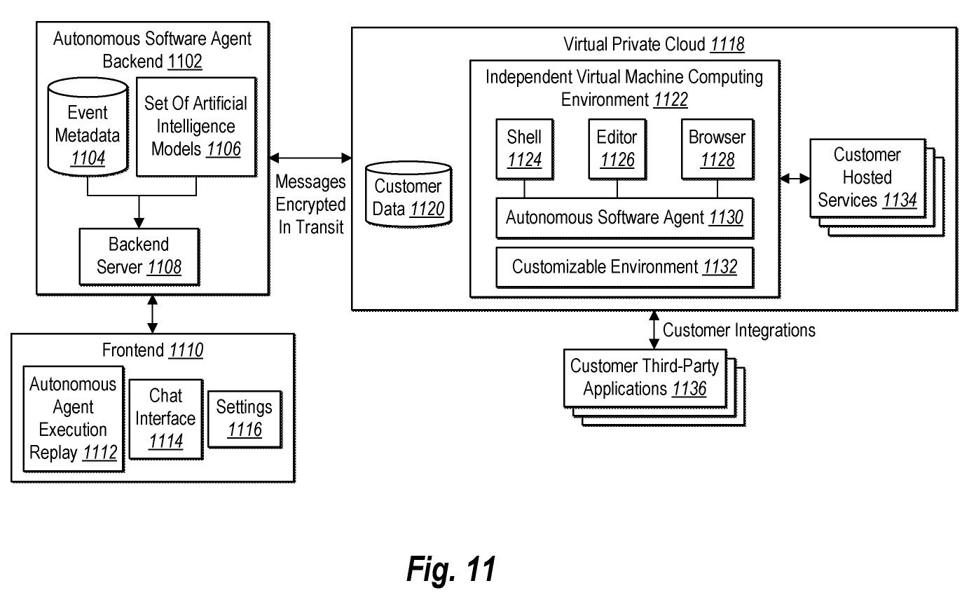

FIG. 11 illustrates additional details of the architecture of the autonomous software agent system 100 in accordance with one or more embodiments. For example, FIG. 11 shows that for each session of deploying an autonomous software agent, the autonomous software agent system 100 spins up/deploys an autonomous software agent backend 1102 that includes a “backend container” paired with “a development box” virtual machine. In other words, the autonomous software agent system 100 initializes a development box (e.g., an independent virtual machine computing environment) with an autonomous software agent backend that includes a set of artificial intelligence models 1106. As mentioned above, the set of artificial intelligence models 1106 contains one or more machine learning/artificial intelligence models shown above used to process, analyze, and generate data.

As shown in FIG. 11, the autonomous software agent backend 1102 includes event metadata 1104 (e.g., context surrounding a prompt/request submitted to a web application interface, a response to the prompt, or other external sources that contain contextual data), the set of artificial intelligence models 1106 (e.g., one or more machine learning models shown and discussed in FIG. 10), and a backend server 1108 (e.g., a server that handles logic, database interactions, authentication, and other services for deploying an autonomous software agent).

Further, FIG. 11 shows the autonomous software agent backend 1102 interacting with a frontend 1110 which includes autonomous agent execution replay 1112 (e.g., replay for a timelapse of a development session, a session replay that is a recording of previous user interactions with the autonomous software agent system 100), chat UI 1114 (e.g., the graphical user interface provided to a user to submit prompts), and settings 1116 (e.g., custom settings established by the autonomous software agent system 100 or by a user).

Moreover, the autonomous software agent backend 1102 communicates with a virtual private cloud 1118 (e.g., a customer virtual private cloud, which is a dedicated and isolated virtual network within a public cloud service) via encrypted messages. In particular, FIG. 11 shows an independent virtual machine computing environment 1122 hosted on the virtual private cloud 1118 and the virtual private cloud 1118 further includes customer data 1120.

Additionally, the independent virtual machine computing environment 1122 further includes a shell 1124, an editor 1126 (e.g., integrated development environment), a browser 1128, an autonomous software agent 1130, a customizable environment 1132 (e.g., playbooks, knowledge, etc. that customize an independent virtual machine computing environment) and customer hosted services 1134 (e.g., services or applications hosted and managed by a tenant organization). Additionally, FIG. 11 shows that the virtual private cloud 1118 can integrate various applications via access tokens/API keys. In particular, the autonomous software agent system can use the independent virtual machine computing environment 1122 (e.g., the autonomous software agent) to write various code and make integrations with applications integrated with the virtual private cloud 1118 (e.g., customer third-party applications 1136).

In one or more embodiments, the autonomous software agent system 100 utilizes a communication between the virtual private cloud 1118 and the autonomous software agent backend 1102 (e.g., that includes the set of artificial intelligence models 1106) to transmit a sub-task of a software task. In particular, in the context of the above discussion, the autonomous software agent system 100 transmits the sub-task to the autonomous software agent backend 1102 to determine an activation trigger. Accordingly, a development session involves the autonomous software agent system 100 leveraging the independent virtual machine computing environment 1122 paired with the autonomous software agent backend 1102.

In one or more embodiments, when deployed within a customer-hosted virtual private cloud 1118, encrypted secret material is stored exclusively within the customer tenant boundary, and decryption keys remain under customer-controlled key management infrastructure. The autonomous software agent backend 1102 may transmit activation trigger metadata but does not receive decrypted token values. Decryption and injection of tokens occur solely within the independent virtual machine computing environment 1122 operating inside the tenant environment. This separation-of-trust architecture prevents the autonomous agent model backend from accessing plaintext secret values while still enabling secure task execution.

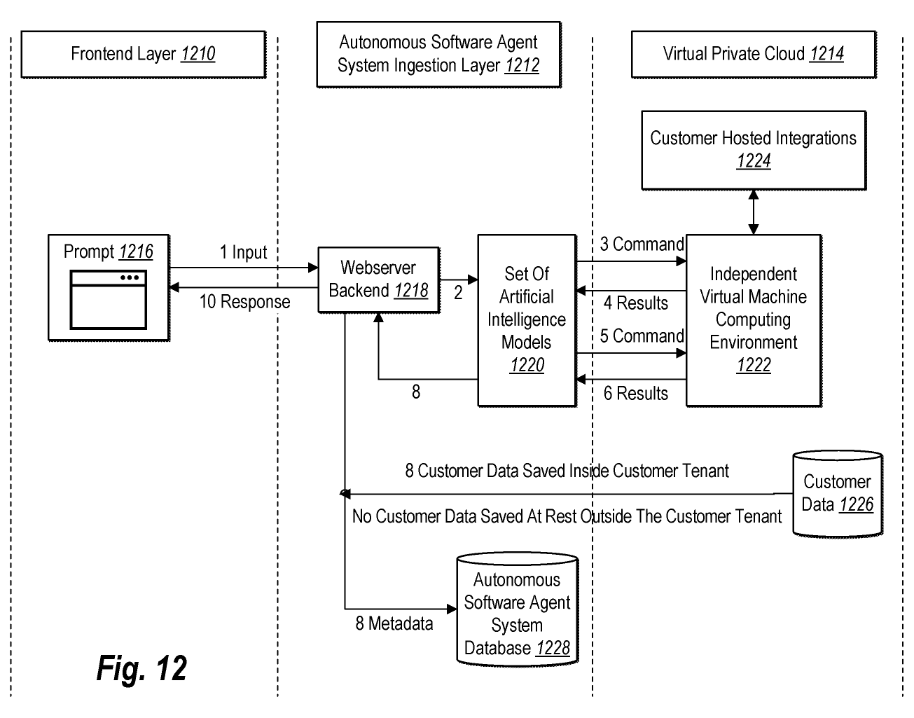

Further, FIG. 12 shows that the autonomous software agent system 100 receives a prompt 1216 via a frontend layer 1210. As shown, the autonomous software agent system 100 passes the prompt 1216 to an autonomous software agent system ingestion layer 1212. In response to the prompt 1216, the autonomous software agent system 100 responds to the prompt 1216 with a webserver backend 1218 and further passes the information to a set of artificial intelligence models 1220 (e.g., one or more artificial intelligence models shown above in FIG. 10).

As further shown in FIG. 12, the autonomous software agent system 100 passes commands/results back and forth between a virtual private cloud 1214 (e.g., an independent virtual machine computing environment 1222) and the set of artificial intelligence models 1220. In other words, FIG. 12 illustrates the interaction between the frontend layer 1210 of the autonomous software agent system 100, the backend of the autonomous software agent system 100, and an autonomous software agent deployed for performing tasks at the virtual private cloud 1214. Furthermore, the independent virtual machine computing environment 1222 also accesses customer hosted integrations 1224 at the virtual private cloud 1214.

Additionally, FIG. 12 shows customer data 1226 at the virtual private cloud 1214, which the autonomous software agent system 100 passes all customer data saved inside the customer tenant to the tenant (e.g., and no customer data is saved at rest outside the customer tenant). Moreover, FIG. 12 shows the autonomous software agent system 100 using the webserver backend 1218 to pass metadata to an autonomous software agent system database 1228.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates an artificial intelligence plan (e.g., breaks down the software task), and further reasons how to complete one or more tasks. In particular, the autonomous software agent system uses the independent virtual machine computing environment 1222 to communicate with the set of artificial intelligence models 1220 (e.g., the artificial intelligence components shown in FIG. 10) to determine which shell commands to make, computer code to write (e.g., in the editor), and webpages to browse.

In one or more embodiments, the autonomous software agent system 100 further utilizes a text encoder to process a prompt/request to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determine a weight for each word within the text prompt to generate a text vector that captures the importance of words within a text prompt, iii) generate low-dimensional text vectors in a continuous vector space that represents words within the text prompt, and/or iv) generate contextualized text vectors by determining semantic relationships between words within the text prompt.

Furthermore, although not shown in FIGS. 7-9, in one or more embodiments, the autonomous software agent system trains the set of artificial intelligence models 1220 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for performing website browsing actions and determining a relevance of certain portions of a website domain page.

Moreover, the autonomous software agent system 100 trains the set of artificial intelligence models 1220 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of the set of artificial intelligence models 1220). Thus, at inference time, the autonomous software agent system 100 performs advanced reasoning tasks fine-tuned for specific use cases.

In addition, as alluded to above, the autonomous software agent system 100 trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., user intervention), the autonomous software agent system 100 learns from the interactions to improve its capabilities. In other words, the autonomous software agent system 100 fine-tunes the artificial intelligence components in response to updates/feedback received from users.

FIGS. 11-12 describe various architectural details of the autonomous software agent system 100. In particular, the architectural components of the autonomous software agent system 100 enable an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code reviews (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

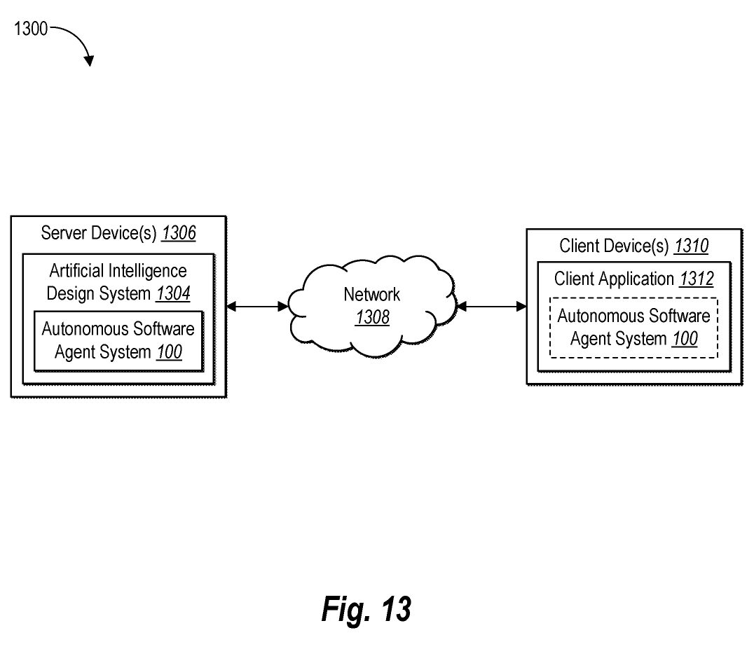

Additional details regarding the autonomous software agent system 100 will now be provided with reference to the figures. For example, FIG. 13 illustrates a schematic diagram of an exemplary system environment 1300 in which an autonomous software agent system 100 operates. As illustrated in FIG. 13, the system environment 1300 includes server device(s) 1306, an artificial intelligence design system 1304, a network 1308, and client device(s) 1310. Additionally, FIG. 13 illustrates that the artificial intelligence design system 1304 includes the autonomous software agent system 100.

Although the system environment 1300 of FIG. 13 is depicted as having a particular number of components, the system environment 1300 is capable of having a different number of additional or alternative components (e.g., a different number of servers, client devices, or other components in communication with the autonomous software agent system 100 via the network 1308). Similarly, although FIG. 13 illustrates a particular arrangement of the server device(s) 1306, the network 1308, and the client device(s) 1310, various additional arrangements are possible.

The server device(s) 1306, the network 1308, and the client device(s) 1310 are communicatively coupled with each other either directly or indirectly (e.g., through the network 1308 discussed in greater detail below). Moreover, the server device(s) 1306 and the client device(s) 1310 include one or more of a variety of computing devices (including one or more computing devices as discussed in greater detail below).

As mentioned above, the system environment 1300 includes the server device(s) 1306. In one or more embodiments, the server device(s) 1306 process input for a request (e.g., a request to configure an autonomous software agent or to deploy an autonomous software agent). In one or more embodiments, the server device(s) 1306 comprise a data server. In some implementations, the server device(s) 1306 comprise a communication server or a web-hosting server. Furthermore, the server device(s) 1306 can be associated with the autonomous software agent system 100 or with an organization/company that deploys the autonomous software agent system 100.

In some embodiments, the client device(s) 1310 includes computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 1310 includes smartphones, tablets, desktop computers, laptop computers, head-mounted-display devices, or other electronic devices. The client device(s) 1310 includes one or more software applications (e.g., the client application 1312) for generating content in accordance with the artificial intelligence design system 1304. In one or more embodiments, the client application 1312 includes a software application hosted on the server device(s) 1306 accessible by the client device(s) 1310 through another application, such as a web browser.

To provide an example implementation, in some embodiments, the autonomous software agent system 100 on the server device(s) 1306 supports the autonomous software agent system 100 on the client device(s) 1310. For instance, in some cases, the artificial intelligence design system 1304 on the server device(s) 1306 gathers data for the autonomous software agent system 100. In response, the autonomous software agent system 100, via the server device(s) 1306, provides the information to the client device(s) 1310. In other words, the client device(s) 1310 obtains (e.g., downloads) the autonomous software agent system 100 from the server device(s) 1306 that is already trained/optimized. Once downloaded, the autonomous software agent system 100 on the client device(s) 1310 is able to perform tasks (e.g., generative software tasks) independent from the server device(s) 1306. In one or more alternative implementations, the autonomous software agent system 100 generates or learns parameters for one or more artificial intelligence models (e.g., used to implement an autonomous software agent) in whole or in part on the client device(s) 1310.

In alternative implementations, the artificial intelligence design system 1304 includes a web hosting application that allows the client device(s) 1310 to interact with content and services hosted on the server device(s) 1306. To illustrate, in one or more implementations, the client device(s) 1310 accesses a software application supported by the server device(s) 1306. In response, the artificial intelligence design system 1304 on the server device(s) 1306 provides tools for monitoring/modifying/generating computer code using the autonomous software agent. In other words, the client device(s) 1310 does not have to download the autonomous software agent system 100 while still being able to access/utilize the trained/optimized tools provided by the artificial intelligence design system 1304 via a web hosting application.

In some embodiments, the autonomous software agent system 100 is implemented in whole, or in part, by the individual elements of the system environment 1300. For instance, although FIG. 13 illustrates the autonomous software agent system 100 implemented or hosted on the server device(s) 1306, different components of the autonomous software agent system 100 are able to be implemented by a variety of devices within the system environment 1300. For example, one or more (or all) components of the autonomous software agent system 100 are implemented by a different computing device or a separate server from the server device(s) 1306. Indeed, as shown in FIG. 13, the client device(s) 1310 includes the autonomous software agent system 100.

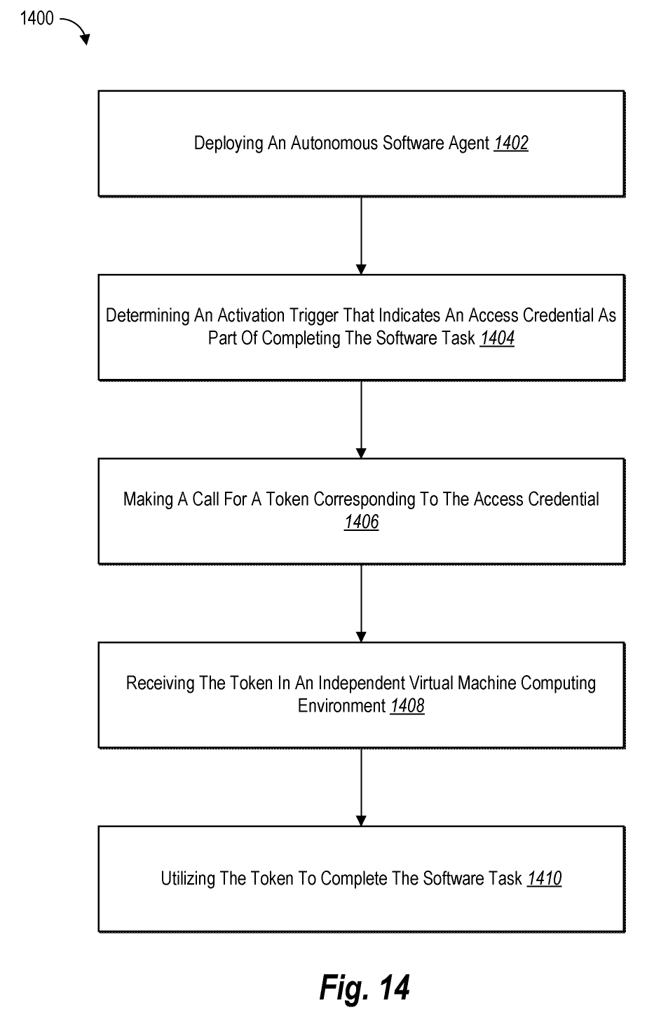

FIG. 14 illustrates a flowchart of a series of acts 1400 for receiving a token in an independent virtual computing environment of an autonomous software agent in accordance with one or more embodiments. FIG. 14 illustrates acts according to one embodiment, alternative embodiments may omit, add to, reorder, and/or modify any of the acts shown in FIG. 14. In some implementations, the acts of FIG. 14 are performed as part of a method. For example, in some embodiments, the acts of FIG. 14 are performed as part of a computer-implemented method. Alternatively, a non-transitory computer-readable medium stores instructions thereon that, when executed by at least one processor, cause a computing device to perform the acts of FIG. 14. In some embodiments, a system performs the acts of FIG. 14. For example, in one or more embodiments, a system includes at least one memory device. The system further includes at least one server device configured to cause the system to perform the acts of FIG. 14.

The series of acts 1400 includes an act 1402 of deploying an autonomous software agent. Further, the series of acts 1400 includes an act 1404 of determining an activation trigger that indicates an access credential as part of completing the software task. Moreover, the series of acts 1400 includes an act 1406 of making a call for a token corresponding to the access credential. Additionally, the series of acts 1400 includes an act 1408 of receiving the token in an independent virtual machine computing environment. Moreover, the series of acts 1400 includes an act 1410 of utilizing the token to complete the software task.

In particular, the act 1402 includes in response to a prompt to execute a software task, deploying an autonomous software agent. Further, the act 1404 includes determining, by the autonomous software agent, an activation trigger that indicates an access credential is required as part of completing the software task. Moreover, the act 1406 includes making a call for a token corresponding to the access credential based on the activation trigger. Additionally, the act 1408 includes receiving, by the autonomous software agent, the token in an independent virtual machine computing environment of the autonomous software agent. Furthermore, the act 1410 includes utilizing, by the autonomous software agent, the token to complete the software task. The series of acts 1400 further includes the following clauses.

Clause 1. A computer-implemented method comprising: in response to a prompt to execute a software task, deploying an autonomous software agent; determining, by the autonomous software agent, an activation trigger that indicates an access credential is required as part of completing the software task; making a call for a token corresponding to the access credential based on the activation trigger; receiving, by the autonomous software agent, the token in an independent virtual machine computing environment of the autonomous software agent; and utilizing, by the autonomous software agent, the token to complete the software task.

Clause 2. The computer-implemented method of clause 1, wherein making the call for the token corresponding to the access credential further comprises determining that the access credential comprises a selection of a redaction option.

Clause 3. The computer-implemented method of any of clauses 1-2, further comprising: injecting the token into computer environment variables of the independent virtual machine computing environment of the autonomous software agent, wherein injecting the token into the computer environment variables scrubs the token from being viewed by a large language model component of the autonomous software agent.

Clause 4. The computer-implemented method of any of clauses 1-3, further comprising: receiving, via a secret access configuration element, the access credential comprising the token and a context in which the access credential is relevant; and receiving, via the secret access configuration element, a secret type and a secret name.

Clause 5. The computer-implemented method of any of clauses 1-4, further comprising: storing the access credential in a secrets library comprising a plurality of access credentials with a plurality of secret types, wherein the plurality of secret types comprises global secrets usable by an autonomous software agent in future development sessions, and repository-specific secrets scoped to a specific code repository.

Clause 6. The computer-implemented method of any of clauses 1-5, wherein making the call for the token further comprises: determining that the access credential is not stored in a secrets library; prompting a graphical user interface to provide a session-specific secret based on the activation trigger; and receiving, by the autonomous software agent, the token from the session-specific secret being submitted via the graphical user interface.

Clause 7. The computer-implemented method of any of clauses 1-6, wherein determining the activation trigger further comprises: determining that the access credential is a time-based one-time password; determining that the access credential is a raw secret; or determining that the access credential is a site cookie.

Clause 8. The computer-implemented method of any of clauses 1-7, further comprising: accessing, from a secrets library, a plurality of secret names; translating the plurality of secret names to be valid computer environment variables according to a set of translation rules; and making the call for the token corresponding to the access credential by utilizing the autonomous software agent to input a valid computer environment variable corresponding to a secret name.

Clause 9. A system comprising: one or more memory devices; and one or more processors coupled to the one or more memory devices, configured to cause the system to: receive, via a secret access configuration element, an access credential comprising a confidential token and a context in which the access credential is relevant; in response to a prompt to execute a software task, deploy an autonomous software agent; generate a language model relevance prompt comprising a first sub-task of the software task; determine an activation trigger for the first sub-task that indicates the access credential is required for completing the first sub-task of the software task based on the language model relevance prompt; and inject the confidential token into computer environment variables of an independent virtual machine computing environment of the autonomous software agent, wherein injecting the confidential token into the computer environment variables scrubs the confidential token from being viewed by a large language model component of the autonomous software agent.

Clause 10. The system of clause 9, wherein the one or more processors are configured to cause the system to: execute the software task by utilizing the autonomous software agent to access at least one of a browser tool to perform one or more navigation actions or a shell tool to submit one or more terminal commands; and determine, via utilizing the browser tool or the shell tool, that the activation trigger indicates the access credential as being required as part of completing the first sub-task.

Clause 11. The system of any of clauses 9-10, wherein the one or more processors are configured to cause the system to: generate an additional language model relevance prompt comprising a second sub-task of the software task; and determine an additional activation trigger for the second sub-task that indicates an additional context in which an additional access credential is relevant based on the additional language model relevance prompt.

Clause 12. The system of any of clauses 9-11, wherein the one or more processors are configured to cause the system to: determine that the first sub-task requires a site cookie; generate the language model relevance prompt comprising contextual data of the first sub-task; and compare, utilizing a large language model, the contextual data of the first sub-task with a plurality of contexts in a secrets library.

Clause 13. The system of any of clauses 9-12, wherein the one or more processors are configured to cause the system to determine that the contextual data of the first sub-task corresponds to the context in which the access credential is relevant based on comparing the contextual data of the first sub-task with the plurality of contexts in the secrets library.

Clause 14. The system of any of clauses 9-13, wherein the one or more processors are configured to cause the system to deploy the autonomous software agent by: initializing a development session comprising the independent virtual machine computing environment hosted on a virtual private cloud and an autonomous agent model backend comprising a set of large language models; and injecting the confidential token into computer environment variables of the independent virtual machine computing environment of the autonomous software agent.

Clause 15. The system of any of clauses 9-14, wherein the one or more processors are configured to cause the system to redact the confidential token from being accessed or viewed by a large language model of the set of large language models in the autonomous agent model backend of the development session.

Clause 16. A non-transitory computer-readable medium storing executable instructions which, when executed by at least one processing device, cause the at least one processing device to perform operations comprising: in response to a prompt to execute a software task, deploying an autonomous software agent; determining, from executing the software task, an activation trigger that indicates an access credential is required as part of completing the software task; making a call for a token corresponding to the access credential based on the activation trigger; and providing the token to the autonomous software agent as a computer environment variable in an independent virtual machine computing environment of the autonomous software agent.

Clause 17. The non-transitory computer-readable medium of clause 16, further comprising: determining that a first sub-task of the software task requires a time-based one-time password; generating a language model relevance prompt comprising contextual data of the first sub-task; and comparing, utilizing a large language model, the contextual data of the first sub-task with a plurality of contexts in a secrets library.

Clause 18. The non-transitory computer-readable medium of any of clauses 16-17, further comprising: determining that the contextual data of the first sub-task corresponds to a context in which the access credential is relevant; determining that a second sub-task of the software task requires a raw secret; generating a language model relevance prompt comprising contextual data of the second sub-task; and comparing, utilizing the large language model, the contextual data of the second sub-task with the plurality of contexts in a secrets library.

Clause 19. The non-transitory computer-readable medium of any of clauses 16-18, further comprising: determining a selection of a redaction option for the token corresponding to the access credential; utilizing the autonomous software agent to make the call for the token by writing a secret name for the access credential in an integrated development environment within the independent virtual machine computing environment; and injecting the token into the secret name written as computer environment variables of the integrated development environment within the independent virtual machine computing environment.

Clause 20. The non-transitory computer-readable medium of any of clauses 16-19, wherein deploying the autonomous software agent further comprises: initializing a development session comprising the independent virtual machine computing environment hosted on a virtual private cloud and an autonomous agent model backend comprising a set of large language models; and transmitting, from executing the software task, encrypted communications between the virtual private cloud that hosts the independent virtual machine computing environment and the autonomous agent model backend, wherein transmitting the encrypted communications comprises transmitting a sub-task of the software task to a large language model of the autonomous agent model backend.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

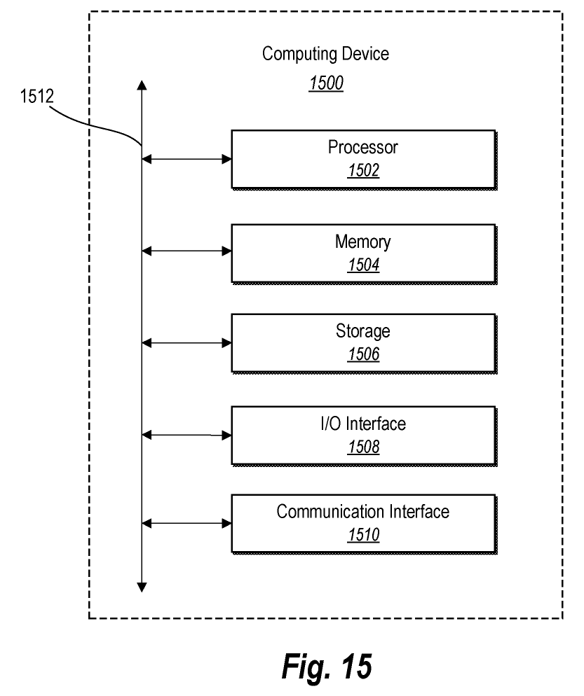

FIG. 15 illustrates a block diagram of an example computing device 1500 that may be configured to perform one or more of the processes described above. One will appreciate that one or more computing devices, such as the computing device 1500 may represent the computing devices described above (e.g., the server device(s) 1306 and/or the client device(s) 1310). In one or more embodiments, the computing device 1500 may be a mobile device (e.g., a mobile telephone, a smartphone, a PDA, a tablet, a laptop, a camera, a tracker, a watch, a wearable device). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 include hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 including storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
in response to a prompt to execute a software task, deploying an autonomous software agent;
determining, by the autonomous software agent, an activation trigger that indicates an access credential is required as part of completing the software task;
making a call for a token corresponding to the access credential based on the activation trigger;
receiving, by the autonomous software agent, the token in an independent virtual machine computing environment of the autonomous software agent; and
utilizing, by the autonomous software agent, the token to complete the software task.

2. The computer-implemented method of claim 1, wherein making the call for the token corresponding to the access credential further comprises determining that the access credential comprises a selection of a redaction option.

3. The computer-implemented method of claim 2, further comprising:
injecting the token into computer environment variables of the independent virtual machine computing environment of the autonomous software agent,
wherein injecting the token into the computer environment variables scrubs the token from being viewed by a large language model component of the autonomous software agent.

4. The computer-implemented method of claim 1, further comprising:
receiving, via a secret access configuration element, the access credential comprising the token and a context in which the access credential is relevant; and
receiving, via the secret access configuration element, a secret type and a secret name.

5. The computer-implemented method of claim 4, further comprising:
storing the access credential in a secrets library comprising a plurality of access credentials with a plurality of secret types,
wherein the plurality of secret types comprises global secrets usable by an autonomous software agent in future development sessions, and repository-specific secrets scoped to a specific code repository.

6. The computer-implemented method of claim 1, wherein making the call for the token further comprises:
determining that the access credential is not stored in a secrets library;
prompting a graphical user interface to provide a session-specific secret based on the activation trigger; and
receiving, by the autonomous software agent, the token from the session-specific secret being submitted via the graphical user interface.

7. The computer-implemented method of claim 1, wherein determining the activation trigger further comprises:
determining that the access credential is a time-based one-time password;
determining that the access credential is a raw secret; or
determining that the access credential is a site cookie.

8. The computer-implemented method of claim 1, further comprising:
accessing, from a secrets library, a plurality of secret names;
translating the plurality of secret names to be valid computer environment variables according to a set of translation rules; and
making the call for the token corresponding to the access credential by utilizing the autonomous software agent to input a valid computer environment variable corresponding to a secret name.

9. A system comprising:
one or more memory devices; and
one or more processors coupled to the one or more memory devices, configured to cause the system to:
receive, via a secret access configuration element, an access credential comprising a confidential token and a context in which the access credential is relevant;
in response to a prompt to execute a software task, deploy an autonomous software agent;
generate a language model relevance prompt comprising a first sub-task of the software task;
determine an activation trigger for the first sub-task that indicates the access credential is required for completing the first sub-task of the software task based on the language model relevance prompt; and
inject the confidential token into computer environment variables of an independent virtual machine computing environment of the autonomous software agent, wherein injecting the confidential token into the computer environment variables scrubs the confidential token from being viewed by a large language model component of the autonomous software agent.

10. The system of claim 9, wherein the one or more processors are configured to cause the system to:
execute the software task by utilizing the autonomous software agent to access at least one of a browser tool to perform one or more navigation actions or a shell tool to submit one or more terminal commands; and
determine, via utilizing the browser tool or the shell tool, that the activation trigger indicates the access credential as being required as part of completing the first sub-task.

11. The system of claim 9, wherein the one or more processors are configured to cause the system to:
generate an additional language model relevance prompt comprising a second sub-task of the software task; and
determine an additional activation trigger for the second sub-task that indicates an additional context in which an additional access credential is relevant based on the additional language model relevance prompt.

12. The system of claim 11, wherein the one or more processors are configured to cause the system to:
determine that the first sub-task requires a site cookie;
generate the language model relevance prompt comprising contextual data of the first sub-task; and
compare, utilizing a large language model, the contextual data of the first sub-task with a plurality of contexts in a secrets library.

13. The system of claim 12, wherein the one or more processors are configured to cause the system to determine that the contextual data of the first sub-task corresponds to the context in which the access credential is relevant based on comparing the contextual data of the first sub-task with the plurality of contexts in the secrets library.

14. The system of claim 13, wherein the one or more processors are configured to cause the system to deploy the autonomous software agent by:
initializing a development session comprising the independent virtual machine computing environment hosted on a virtual private cloud and an autonomous agent model backend comprising a set of large language models; and
injecting the confidential token into computer environment variables of the independent virtual machine computing environment of the autonomous software agent.

15. The system of claim 14, wherein the one or more processors are configured to cause the system to redact the confidential token from being accessed or viewed by a large language model of the set of large language models in the autonomous agent model backend of the development session.

16. A non-transitory computer-readable medium storing executable instructions which, when executed by at least one processing device, cause the at least one processing device to perform operations comprising:
in response to a prompt to execute a software task, deploying an autonomous software agent;
determining, from executing the software task, an activation trigger that indicates an access credential is required as part of completing the software task;
making a call for a token corresponding to the access credential based on the activation trigger; and
providing the token to the autonomous software agent as a computer environment variable in an independent virtual machine computing environment of the autonomous software agent.

17. The non-transitory computer-readable medium of claim 16, further comprising:
determining that a first sub-task of the software task requires a time-based one-time password;
generating a language model relevance prompt comprising contextual data of the first sub-task; and
comparing, utilizing a large language model, the contextual data of the first sub-task with a plurality of contexts in a secrets library.

18. The non-transitory computer-readable medium of claim 17, further comprising:
determining that the contextual data of the first sub-task corresponds to a context in which the access credential is relevant;
determining that a second sub-task of the software task requires a raw secret;
generating a language model relevance prompt comprising contextual data of the second sub-task; and
comparing, utilizing the large language model, the contextual data of the second sub-task with the plurality of contexts in a secrets library.

19. The non-transitory computer-readable medium of claim 16, further comprising:
determining a selection of a redaction option for the token corresponding to the access credential;
utilizing the autonomous software agent to make the call for the token by writing a secret name for the access credential in an integrated development environment within the independent virtual machine computing environment; and
injecting the token into the secret name written as computer environment variables of the integrated development environment within the independent virtual machine computing environment.

20. The non-transitory computer-readable medium of claim 16, wherein deploying the autonomous software agent further comprises:
initializing a development session comprising the independent virtual machine computing environment hosted on a virtual private cloud and an autonomous agent model backend comprising a set of large language models; and
transmitting, from executing the software task, encrypted communications between the virtual private cloud that hosts the independent virtual machine computing environment and the autonomous agent model backend,
wherein transmitting the encrypted communications comprises transmitting a sub-task of the software task to a large language model of the autonomous agent model backend.
